(19) United States
(12) Patent Application Publication
(10) Pub. No.: US 2011/0299368 A1
(43) Pub. Date: Dec. 8, 2011

(54) SYSTEM FOR RECORDING DATA IN AN OPTICAL DISC

(75) Inventor: Tomoyuki Maekawa, Kanagawa-ken (JP)

(73) Assignee: KABUSHIKI KAISHA TOSHIBA, Tokyo (JP)

(21) Appl. No.: 13/151,429

(22) Filed: Jun. 2, 2011

(30) Foreign Application Priority Data
Jun. 3, 2010 (JP) 2010-127454

(51) Int. Cl. G11B 7/085; G11B 7/00

(52) U.S. Cl. 369/30.03; 369/100; G9B/7; G9B/7.042

(57) ABSTRACT

According to one embodiment, a system is provided for recording data in an optical disc having frames having different numbers. The system records data in each of the frames while writing synchronization information in each frame. The system is provided with an even/odd frame judgment unit, a synchronization information output unit, a synchronization information selection unit and a selection information output unit. The even/odd frame judgment unit judges whether the number of a frame having a land pre-pit is an even number or an odd number. The synchronization information output unit outputs plural pieces of synchronization information corresponding to different synchronization patterns. The synchronization information selection unit generates a selection signal for selecting one of the pieces of synchronization information to be written in each frame. The selection information output unit outputs the selected one of the pieces of synchronization information.

### CROSS-REFERENCE TO RELATED APPLICATION(S)

This application is based upon and claims the benefit of priority from the prior Japanese Patent Application No. 2010-127454, filed on Jun. 3, 2010, the entire contents of which are incorporated herein by reference.

### FIELD

Embodiments described herein relate generally to a system for recording data in an optical disc.

### BACKGROUND

DVD-R/RW discs, i.e., recordable optical discs, are widely used. The DVD-R/RW standard prescribes, in order to represent physical addresses on a disc, that a groove serving as a recording track is wobbled with a predetermined cycle and that land pre-pits (LPP) are formed in a land adjacent to the groove. When the minimum unit of data is 1 ch (channel), the cycle of one (1) wobble is defined as 186 ch. Further, the land pre-pits are formed at an apex of the wobble.

An optical disc recording apparatus forms pits in a groove of a DVD-R/RW disc to record data. In this case, “existing of a pit” represents a mark, and “absence of a pit” represents a space.

Data to be recorded in the DVD-R/RW disc is divided in units of frames in advance. One sector is formed of 26 frames, and one ECC (Error Check and Correction) block serving as an information block is formed of 16 sectors.

Frame numbers “zero (0)” to “25” are given to the 26 frames, and each of the frame is classified into an even-numbered frame (hereinafter, simply mentioned as “even frame”) or an odd-numbered frame (hereinafter, simply mentioned as “odd frame”) according to each of the frame number. There are eight wobbles in one frame. Three land pre-pits are usually arranged at the positions of three wobbles which are formed in the head of an even frame, respectively. One set of land pre-pits indicates information of three bits. The values of the three bits are given according to a predetermined rule. The first bit is always “one (1)”.

The optical disc recording apparatus detects the land pre-pits to determine a recording position, in recording data. A synchronization pattern of ““14T”” is provided at the head of each frame to record synchronization information. “T” represents a reference signal length. In the DVD-R/RW standard, it is possible to select whether the synchronization pattern giving the synchronization information is composed of a mark of ““14T”” or a space of ““14T””.

When synchronization information is recorded in a frame having land pre-pits by arranging a synchronization pattern of the mark of ““14T”” in the frame, adjacent land pre-pits may be affected by irradiation of a laser beam for recording and may be deformed so that it may be difficult to detect the land pre-pits. In order to avoid this problem, the synchronization pattern of the frame having the land pre-pits only has to be a space always. In other words, the synchronization pattern of an even frame usually having pre-pits only has to be a space of ““14T”” always.

As described above, from the viewpoint of influence on land pre-pits, all synchronization patterns giving the synchronization information are preferably formed of spaces of ““14T”” respectively. However, this formation may increase low-frequency component in recorded data. When recorded data contain much low-frequency component, the low-frequency component may leak into a servo signal of an optical pickup during reproduction, and this may cause bad affect on the servo operation. In order to avoid this problem, a suggestion is made. The suggestion is alternating arranging a space of ““14T”” and a mark of ““14T”” as the synchronization patterns giving synchronization information. In this suggestion, an even frame has a space of ““14T”” as a synchronization pattern giving synchronization information, and an odd frame has a mark of ““14T”” as a synchronization pattern giving synchronization information

Since the DVD-R/RW disc adopts a CLV (Constant Line Velocity), the number of sectors per circle gradually increases from an inner periphery to an outer periphery. Thus, when each land pre-pit is always arranged in an even frame, positions of land pre-pits may be arranged side by side between adjacent tracks at a plurality of positions from the inner periphery to the outer periphery of the disc. In this case, crosstalk may occur between the land pre-pits of the adjacent tracks, and this may make it difficult to read the land pre-pits correctly.

In order to avoid this problem, the DVD-R/RW standard prescribes that, when a position of a land pre-pit in a certain circle is to some extent in proximity to a position of a land pre-pit of a last circle, the land pre-pit of the certain circle is not formed in an even frame but in an odd frame. In this case, however, the proximity distance, at which a land pre-pit is deemed to be in proximity, is not specifically defined as a numerical value. Setting transition from an even frame to an odd frame is basically left to disc manufacturers.

As described above, a land pre-pit is basically arranged in an even frame, but depending on the position of a track, it may be arranged in an odd frame. Thus, when the synchronization pattern giving synchronization information of each frame is alternately a space of ““14T”” and a mark of ““14T”” as described above, and the arrangement of the land pre-pit changes to an odd frame, a synchronization pattern of a mark of ““14T”” is arranged adjacent to the land pre-pit.

### BRIEF DESCRIPTION OF THE DRAWINGS

FIG. 1 is a block diagram illustrating a system for recording data in an optical disc according to a first embodiment;

FIG. 2A illustrates a relationship between a wobble signal and a wobble address at which a land pre-pit is arranged;

FIG. 2B illustrates a relationship among a wobble address, synchronization data and information data;

FIG. 3 is a block diagram illustrating an example of a land pre-pit (LPP) decoder for decoding land pre-pit data according to the first embodiment;

FIG. 4 is a diagram for explaining operation of the land pre-pit (LPP) decoder;

FIG. 5 is an explanatory diagram illustrating a structure of a sector of a disc;

FIG. 6 illustrates an example of flow of selecting and recording operation of synchronization information in the system according to the first embodiment;

FIG. 7 illustrates waveforms of signals generated when the system of the first embodiment is operated;

FIG. 8 is a block diagram illustrating a system for recording data in an optical disc according to a second embodiment;

FIG. 9 is a flow diagram illustrating an example of processing of storing in a storage unit, address information of a frame changed to an even/odd frame, which is used in the system according to the second embodiment;

FIG. 10 illustrates an example of address information and transition directions for transitioning to an even/odd frame which are to be stored in the storage unit;

FIG. 11 illustrates an example of flow of selecting and recording operation of synchronization information in the system according to the second embodiment;

FIG. 12 illustrates waveforms of signals generated when the system of the second embodiment is operated;

FIG. 13 is a block diagram illustrating a system for recording data in an optical disc according to a third embodiment;

FIG. 14 is a block diagram illustrating an example of a land pre-pit (LPP) decoder for decoding land pre-pit data according to the third embodiment;

FIG. 15 is a block diagram illustrating a system for recording data in an optical disc according to a fourth embodiment;

FIG. 16 is a circuit diagram illustrating a configuration of an LPP pattern detection unit;

FIG. 17 illustrates waveforms of signals and a detection result of LPP pattern generated by the LPP pattern detection unit;

FIG. 18 is a circuit diagram illustrating a wobble counter and a setting unit to set the wobble counter;

FIG. 19 illustrates waveforms of signals and digital values generated from the circuit of FIG. 18;

FIG. 20 is a circuit diagram illustrating a frame counter and a setting unit to set the frame counter;

FIGS. 21 and 22 illustrate waveforms of signals and digital values generated from the circuit of FIG. 20;

FIG. 23 is a circuit diagram illustrating a structure of an even/odd frame judgment unit;

FIGS. 24-29 are circuit diagrams illustrating logic circuits used in the first embodiment, respectively; and

FIGS. 30 and 31 illustrate waveforms and digital values of signals which are inputted into a sector counter and a sector address decoding unit used in the first embodiment, respectively.

### DETAILED DESCRIPTION

According to one embodiment, a system is provided for recording data in an optical disc having frames having different numbers. The system records data in each of the frames while writing synchronization information in each frame. The system is provided with an even/odd frame judgment unit, a synchronization information output unit, a synchronization information selection unit and a selection information output unit.

The even/odd frame judgment unit is configured to judge whether the number of a frame having a land pre-pit is an even number or an odd number, on the basis of a signal obtained by detecting the land pre-pit. The synchronization information output unit is configured to output plural pieces of synchronization information corresponding to different synchronization patterns. The synchronization information selection unit is configured to generate a selection signal for selecting one of the pieces of synchronization information to be written in each frame, on the basis of the judgment result obtained from the even/odd frame judgment unit. The selection information output unit is configured to output the selected one of the pieces of synchronization information on the basis of the selection signal obtained from the synchronization information selection unit.

Hereinafter, further embodiments will be described with reference to the drawings.

In the drawings, the same reference numerals denote the same or similar portions respectively.

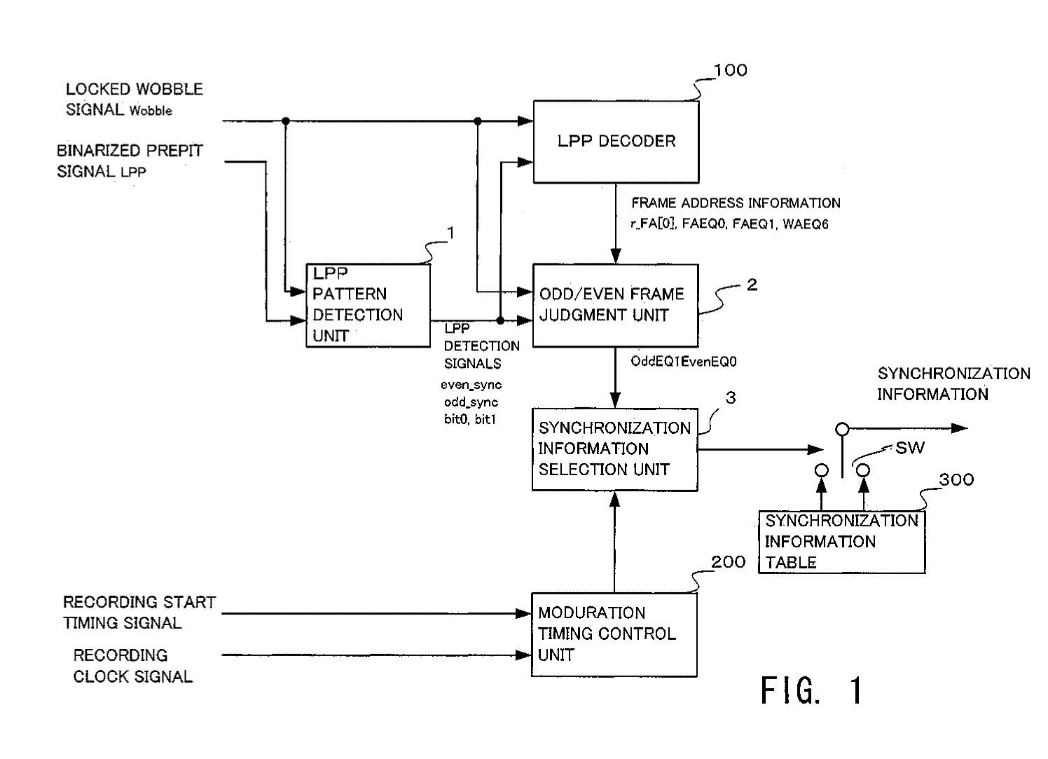

A first embodiment will be described with reference to FIG. 1. FIG. 1 is a block diagram illustrating a system for recording data in an optical disc according to the first embodiment.

In the system for recording data in an optical disc, a light reflected from an optical disc is received by a pair of light receiving elements. An analog signal is obtained based on a difference of electric signals provided from the light receiving elements. The difference of the electric signals is obtained in order to control servo for tracking and to detect a land pre-pit. A locked wobble signal and a binary pre-pit signal are obtained from the analog signal. The locked wobble signal is a signal obtained by locking and stabilizing a low-frequency component of the analog signal detected from the optical disc in a PLL circuit. The binary pre-pit signal is a signal obtained by slicing the analog signal with an appropriate slice level.

As shown in FIG. 1, similar to an ordinary system for recording data in an optical disc, the system according to the embodiment is provided with a land pre-pit decoder (hereinafter referred to as “LPP decoder”) 100, a modulation timing control unit 200, and a synchronization information table 300 serving as a synchronization information output unit for storing and outputting plural pieces of synchronization information corresponding to predetermined synchronization patterns.

The LPP decoder 100 generates frame address information R_FA[0], FAEQ0, FAEQ1, WAEQ6 and sector address information on each ECC block formed on an optical disc, on the basis of a locked wobble signal Wobble and LPP detection signals even_sync, odd_sync, bit0 and bit1, which will be described in detail below.

The modulation timing control unit 200 receives a recording start timing signal and a recording clock signal. The modulation timing control unit 200 controls recording timing of a modulation signal to record the signal in the optical disc.

The modulation timing control unit 200 controls output timing of synchronization information to be caused by a synchronization information selection unit 3 described in detail below.

The synchronization information table 300 stores at least plural pieces of synchronization information respectively corresponding to a synchronization pattern of a mark of “14T” and a synchronization pattern of a space of “14T”.

The optical disc recording system is further provided with a land pre-pit pattern detection unit (hereinafter referred to as “LPP pattern detection unit”) 1, an even/odd frame judgment unit 2, and a synchronization information selection unit 3. The LPP pattern detection unit 1 detects a land pre-pit pattern based on the locked wobble signal Wobble and the binary pre-pit signal LPP. The LPP pattern detection unit 1 outputs the LPP detection signals even_sync, odd_sync, bit0, bit1.

The even/odd frame judgment unit 2 judges whether a frame, from which a pattern of land pre-pits is detected by the LPP pattern detection unit 1, is an even frame or an odd frame, on the basis of the locked wobble signal Wobble, the LPP detection signals even_sync, odd_sync, bit0, bit1, and the frame address information obtained from the LPP decoder 100.

The synchronization information selection unit 3 selects a type of a recording pattern of synchronization information to be recorded in each of the frames, on the basis of a judgment result OddEQ1EvenEQ0 provided from the even/odd frame judgment unit 2.

More specifically, a switch SW serving as a selection information output unit is switched based on a selection signal provided from the synchronization information selection unit 3. Synchronization information, which corresponds to one of synchronization patterns representing a mark of “14T” and a space of “14T” and are stored in the synchronization pattern table 300, is selectively outputted.

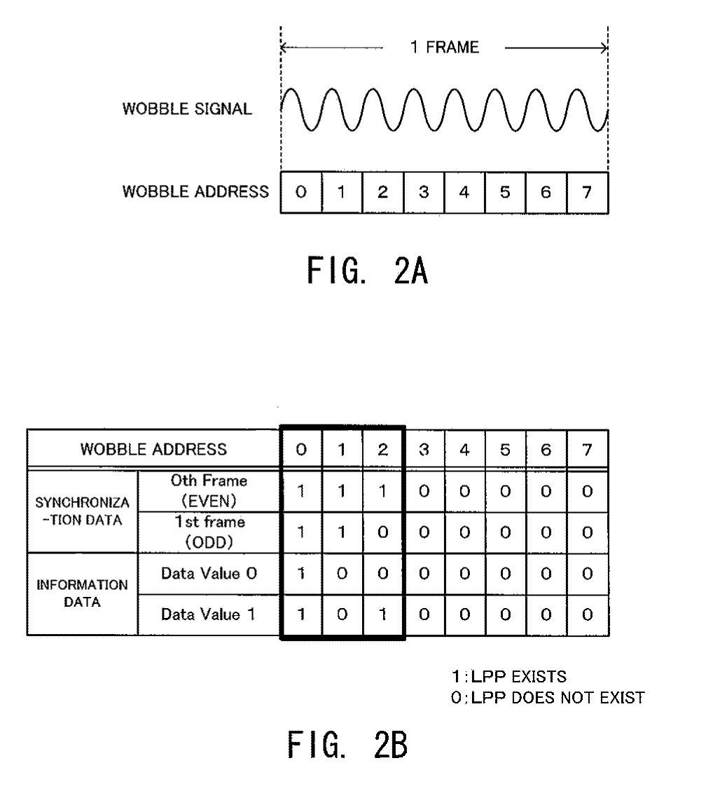

FIG. 2A illustrates relationship between a wobble signal and wobble addresses in which land pre-pits are arranged in one frame. FIG. 2B illustrates relationship between the wobble addresses, synchronization data, and information data

In FIG. 2A, the land pre-pits are arranged respectively in wobble addresses 0, 1, 2 representing three wobble positions at the head of the frame.

In FIG. 2B, when existing of the land pre-pit is represented as “1”, and absence of the land pre-pit is represented as “0”, the contents of data represented by patterns of land pre-pits are distinguished based on whether the land pre-pit exists or not in each of the three wobbles. The contents of data include synchronization data and information data.

In FIG. 2B, when land pre-pits are arranged in an even frame, synchronization data “111” is recorded in the 0th frame. On the other hand, when land pre-pits are arranged in an odd frame, synchronization data “110” is recorded in the first frame.

12 bits of information data is recorded in the second and the subsequent frames per one sector, as will be described in detail below. Information data “100” represents a data value “0”, and information data “101” represents a data value “1”. The purpose of using the information data in the system will be described below.

In the first four bits of the above 12 bits of information data, sector address information (Relative Address) within an ECC block is embedded. In the remaining eight bits, ECC block address information is embedded.

The LPP pattern detection unit 1 of FIG. 1 analyzes the binary pre-pit signal. When the LPP pattern detection unit 1 analyzes the binary pre-pit signals and detects a “bit arrangement” corresponding to any one of the patters of data shown in FIG. 2B, the LPP pattern detection unit 1 outputs any one of land pre-pit detection signals even_sync, odd_sync, bit0, bit1.

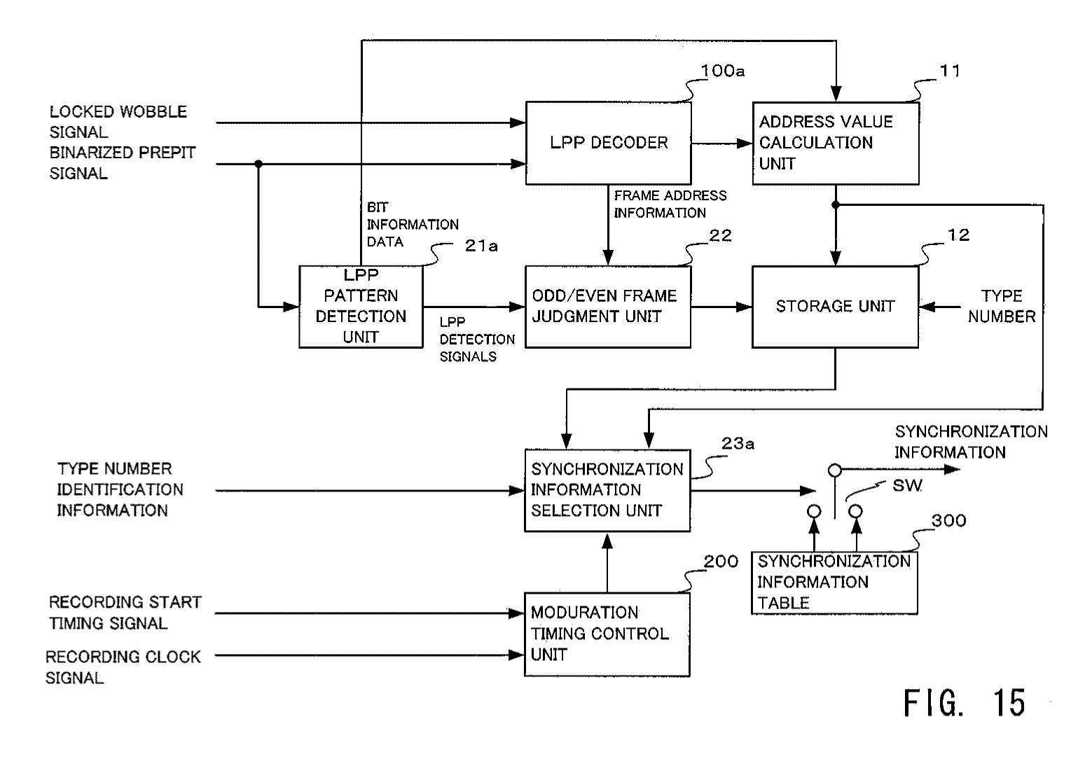

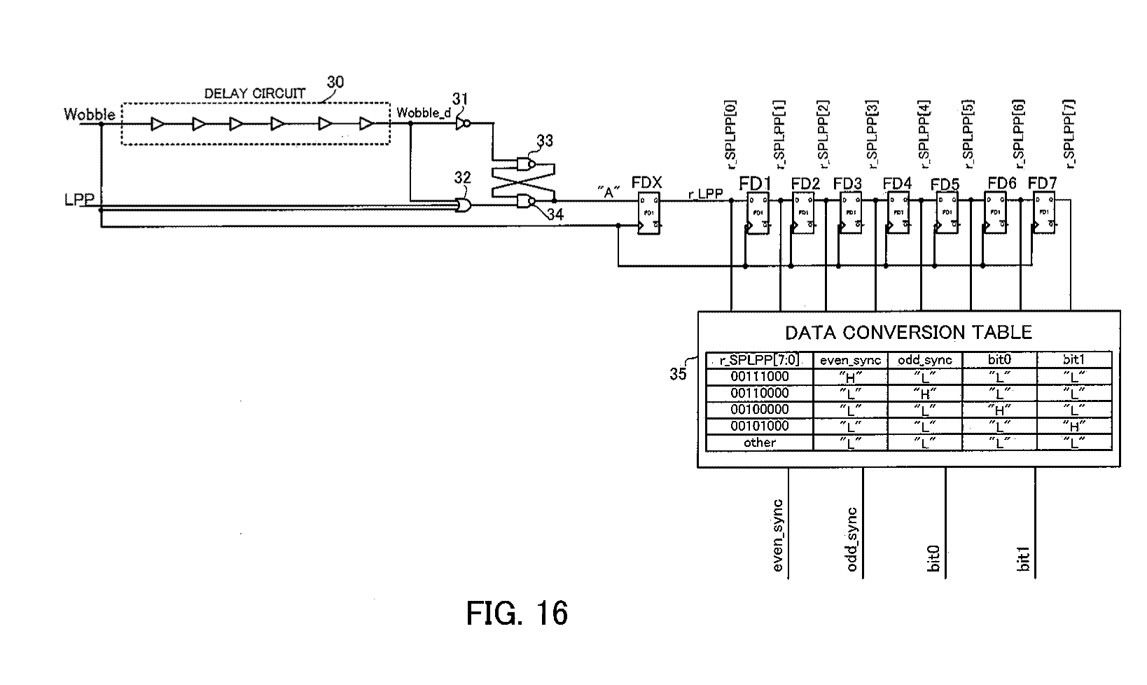

The circuit configuration of the LPP pattern detection unit 1 is shown in FIG. 16. An output terminal of a delay circuit 30 receiving the locked wobble signal Wobble is connected to an input terminal of an inverter 31 and an input terminal of an OR gate 32 receiving a binary pre-pit signal LPP.

The locked wobble signal Wobble is provided to the other input terminal of the OR gate 32. An output terminal of the inverter 31 is connected to an input terminal of a NAND gate 33. An output terminal of the OR gate 32 is connected to an input terminal of a NAND gate 34. The input/output terminals of the NAND gates 33, 34 are cross-connected. An output terminal of the NAND gate 34 is connected to an input terminal of a D-type flip-flop FDX.

An output terminal of the D-type flip-flop FDX is connected to an input terminal of a D-type flip-flop FD1. Output terminals of D-type flip-flops FD1 to FD6 are respectively connected to input terminals of D-type flip-flops FD2 to FD7. The binary pre-pit signal LPP is inputted to clock lock input terminals of the D-type flip-flops FD1 to FD7.

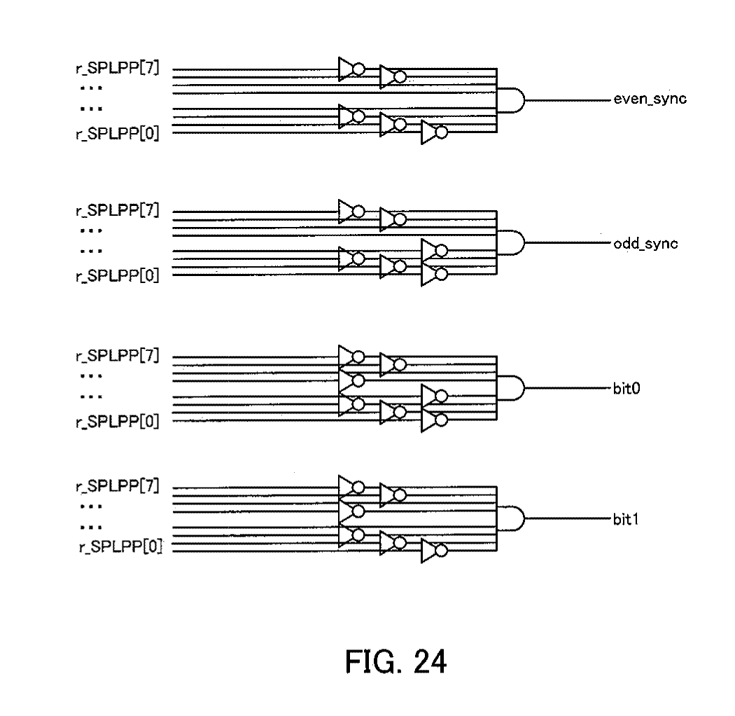

Out put signals r_LPP, r_SPLPP[0] to r_SPLPP[7] of the D-type flip-flops FDX and FD1 to FD7 are inputted to a data conversion table 35. The data conversion table 35 is, for example, a circuit composed of inverters and AND gates shown in detail in FIG. 24. The data conversion table 35 outputs the above land pre-pit detection signals even_sync, odd_sync, bit0, bit1.

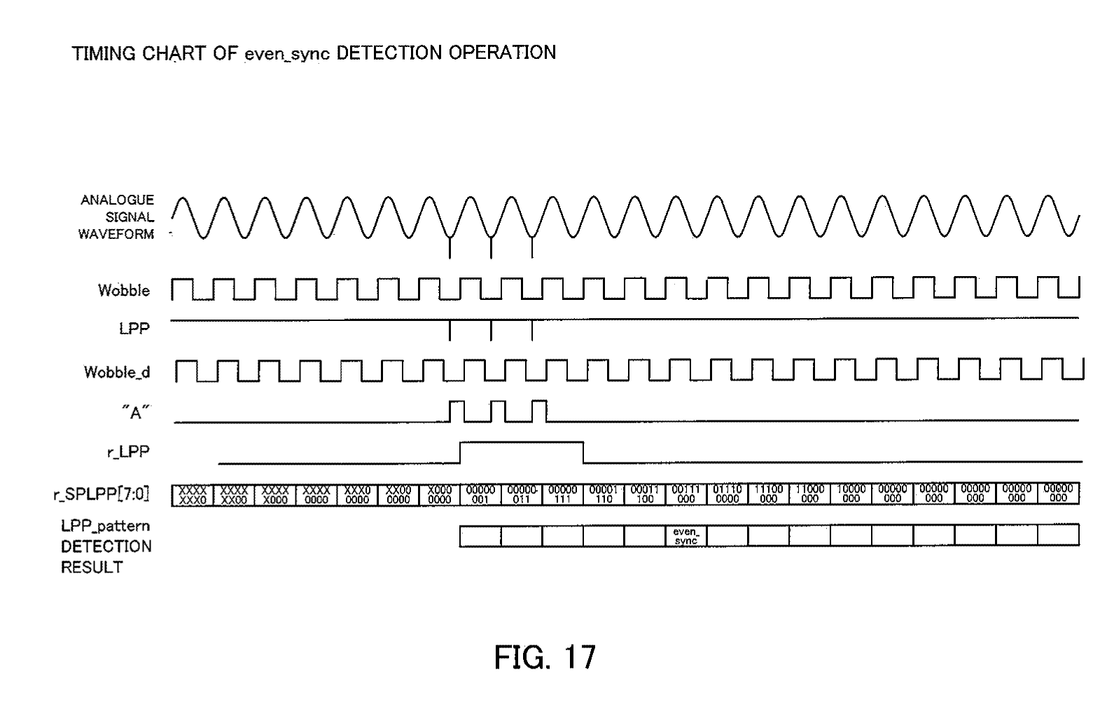

FIG. 17 shows an analog signal, i.e., a difference of electric signals provided from a pair of light receiving elements, waveforms of the signals of respective portions of the LPP pattern detection unit 11.e. Wobble, LPP, Wobble_d, “A”, r_LPP, a digital value r_SPLPP[7:0], and a detection result of an LPP pattern. “[7:0]” means that there are digits from the “0”-th digit to the “7”-th digit. In this example, “even_sync” is detected as a land pre-pit detection signal.

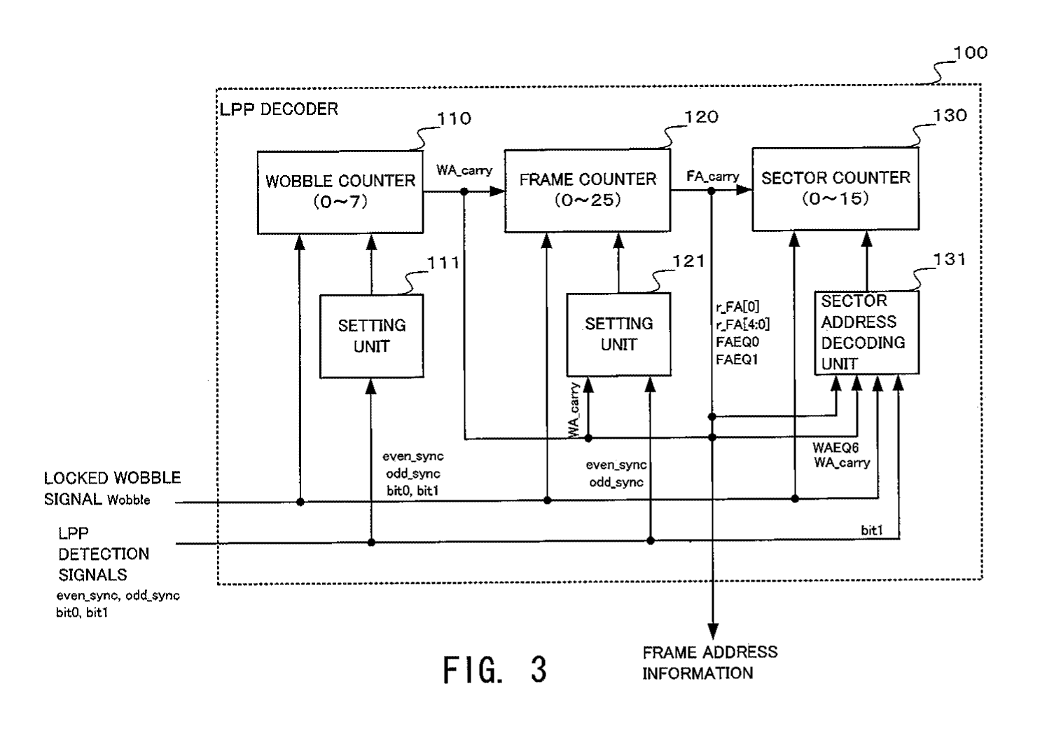

FIG. 3 illustrates an example of an internal structure of the LPP decoder 100 shown in FIG. 1.

The LPP decoder 100 is provided with a wobble counter 110, a frame counter 120, and a sector counter 130. The wobble counter 110 counts locked wobble signals 0 to 7. The frame counter 120 counts output signals 0 to 25 provided from the wobble counter 110. The sector counter 130 counts output signals 0 to 15 provided from the frame counter 120. Further, the LPP decoder 100 is provided with setting units 111, 121 and a sector address decoding unit 131.

The setting unit 111 receives the locked wobble signal and the LPP detection signal, and outputs a detection signal of three wobbles having land pre-pits to the wobble counter 110. The wobble counter 110 forcibly sets the counter value to “7” on the basis of the output of the setting unit 111.

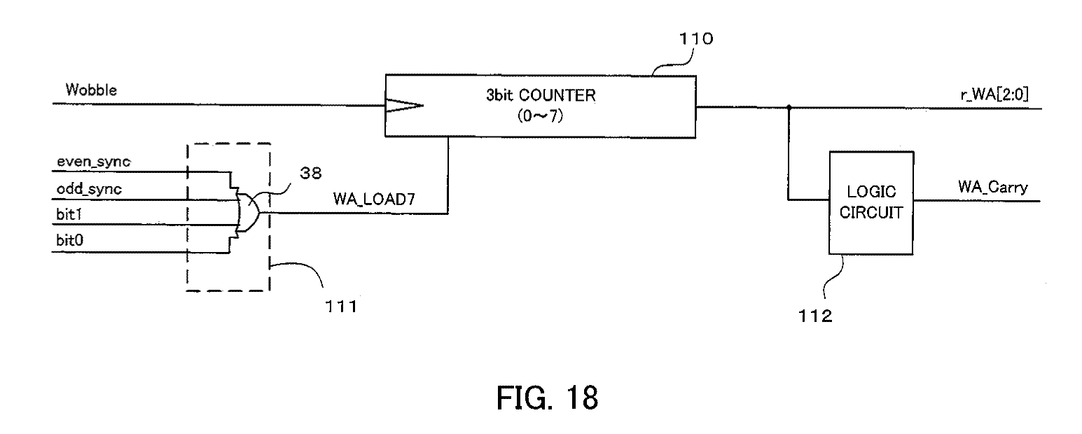

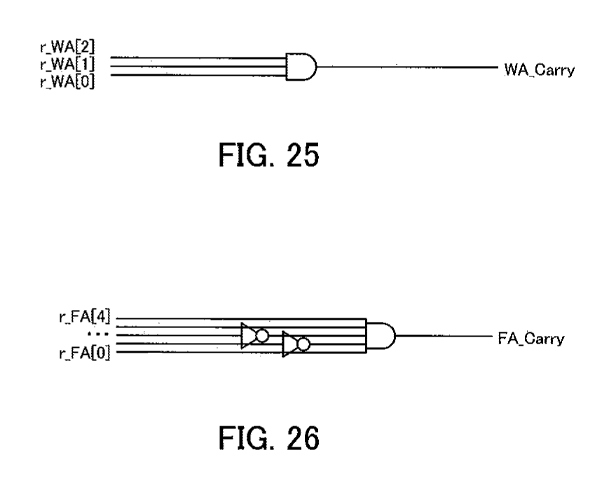

FIG. 18 is a circuit configuration illustrating the wobble counter 110 and the setting unit 111. The locked wobble signal Wobble is provided to a clock input terminal of the wobble counter 110. The setting unit 111 is composed of an OR gate 38. The land pre-pit detection signals even_sync, odd_sync, bit0, bit1 are provided to input terminals of the OR gate 38. An output terminal of the OR gate 38 is connected to the wobble counter 110. A signal WA_LOAD7 is outputted from the output terminal of the OR gate 38. The signal WA_LOAD7 forcibly changes the counter value of the wobble counter 110 to “7”. Signals r_WA[3:0] of respective digits and a carry up signal WA_Carry are outputted from the wobble counter 110. An output terminal of the wobble counter 110 is connected to a logic circuit 112. The logic circuit 112 is, for example, an AND gate shown in detail in FIG. 25 and outputs a carry-up signal WA_Carry.

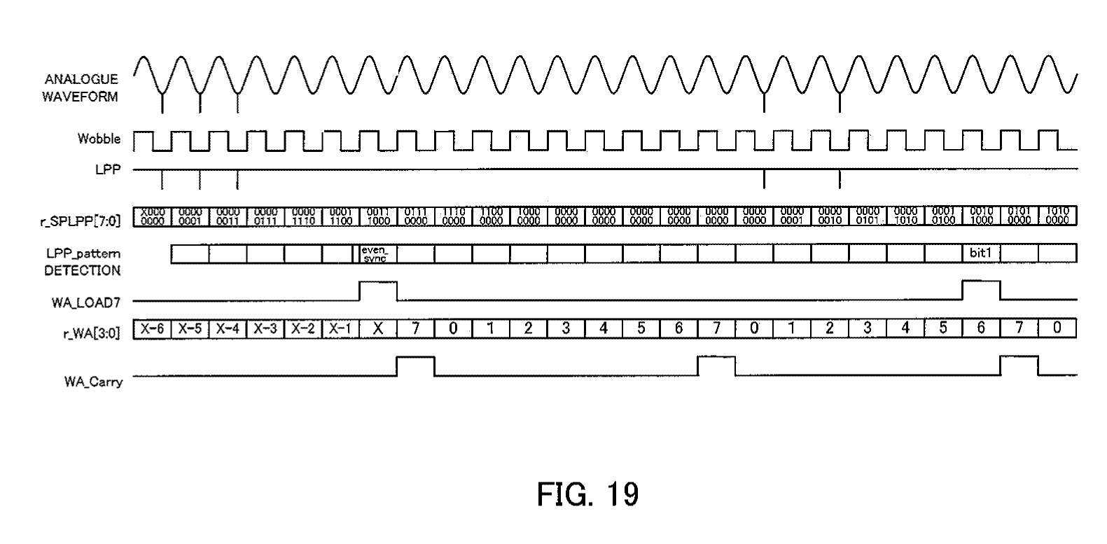

FIG. 19 illustrates waveforms of signals and digital values generated from the wobble counter 110 and the setting unit 111 of FIG. 18. When the wobble counter 110 is set (loaded) in response to the signal WA_LOAD7, the wobble counter 110 repeats counting 0 to 7.

The setting unit 121 receives an LPP detection signal and a carry up signal outputted from the wobble counter 110, and outputs a setting signal to the frame counter 120. When the synchronization data of the land pre-pits initially detected by the setting unit 121 is “11100000”, the frame counter 120 forcibly sets the counter value to “0”. When the synchronization data is “11000000”, the frame counter 120 forcibly sets the counter value to “1”. As will be described below, the setting unit 121 also outputs a signal for setting the counter value of the frame counter 120 to “2”.

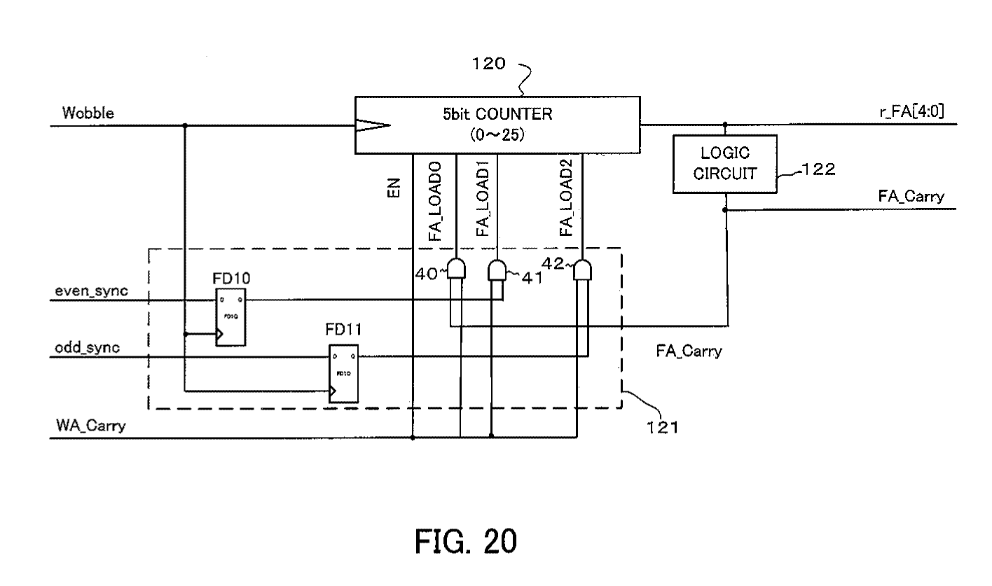

FIG. 20 illustrates a circuit configuration of the frame counter 120 and the setting unit 121. The setting unit 121 is provided with D-type flip-flops FD10, FD11 and AND gates 40 to 42. The locked wobble signal Wobble is provided to each clock input terminal of the flip-flops FD10, FD11. The land pre-pit detection signals even_sync, odd_sync are inputted to each data input terminal of the flip-flops FD10, FD11.

The carry up signal WA_Carry is provided to one input terminals of the AND gates 40 to 42. The land pre-pit detection signals even_sync, odd_sync are respectively provided to the other input terminals of the AND gates 41, 42, respectively. The carry up signal FA_Carry outputted from the frame counter 120 is provided to the other input terminal of the AND gate 40. The frame counter 120 outputs a signal r_FA[4:0] of each digit.

An output terminal of the frame counter 120 is connected to a logic circuit 122. The logic circuit 122 is, for example, circuit composed of inverters and an AND gate shown in detail in FIG. 26, and outputs a carry-up signal FA_Carry. The carry-up signal FA_Carry from the logic circuit 122 is provided to the other input terminals of the AND gate 40.

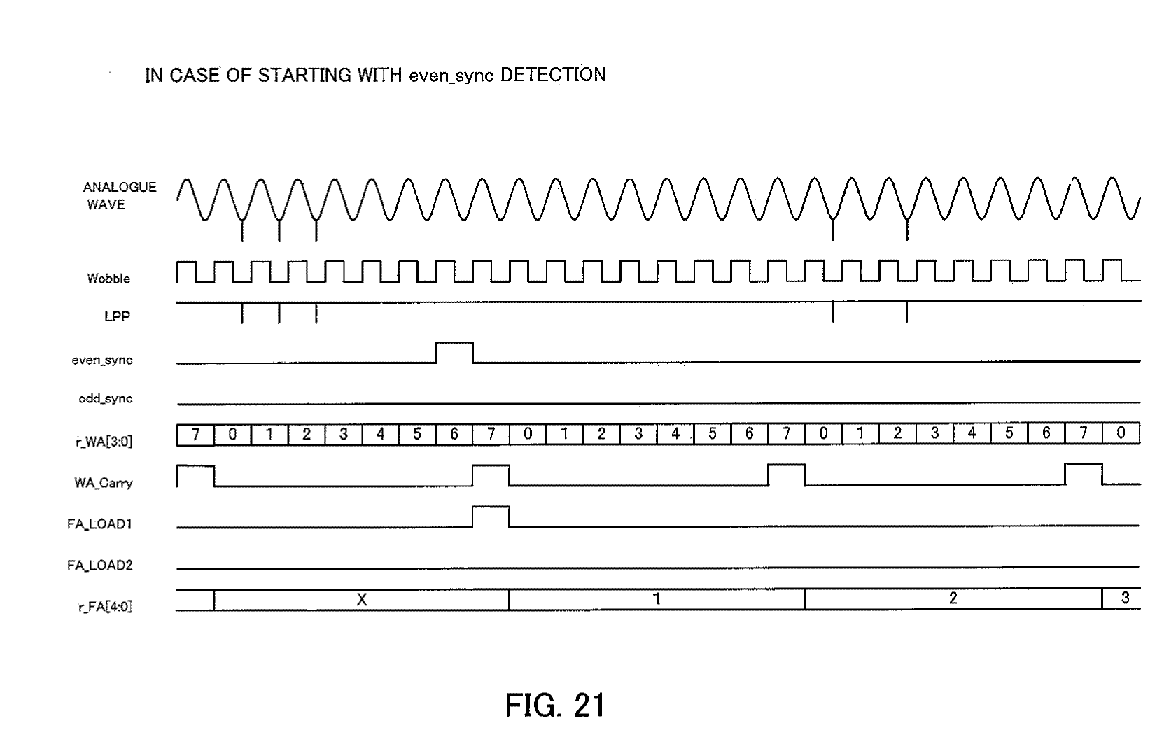

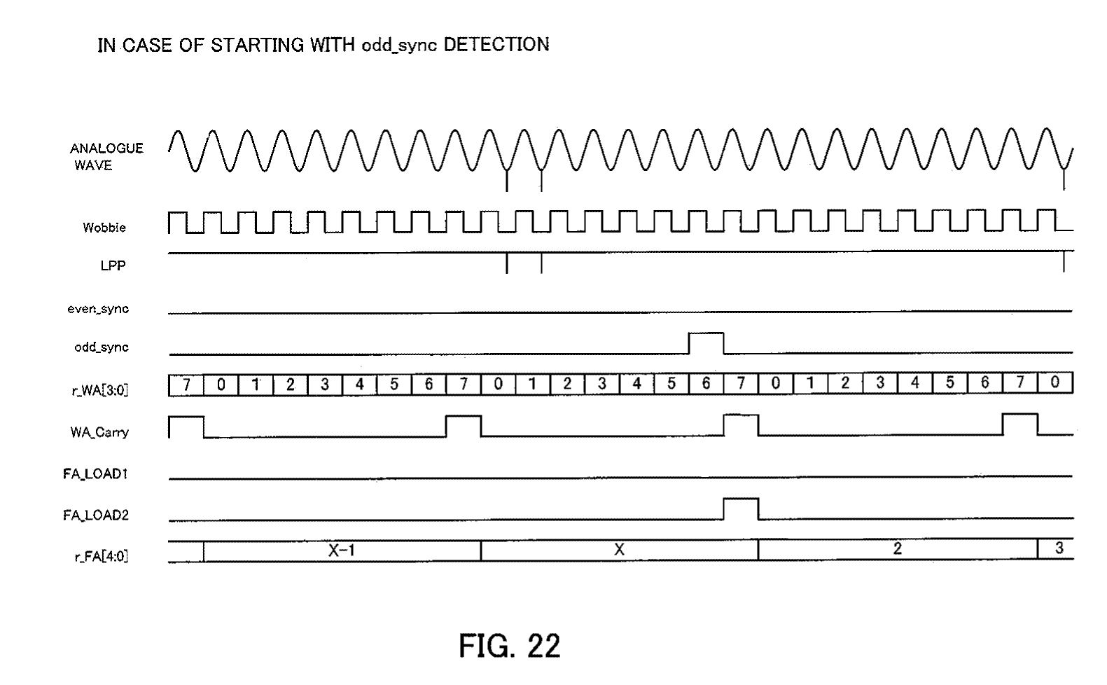

FIGS. 21 and 22 illustrate waveforms of signals and digital values generated from generated from the frame counter 120 and the setting unit 121 of FIG. 20. FIG. 21 illustrates a case where counting is started by detecting even_sync. FIG. 22 illustrates a case where counting is started by detecting odd_sync. Once the frame counter 110 is set (loaded) by signals FA_LOAD0, FA_LOAD1 and FA_LOAD2, the frame counter 110 repeats the counting of 0 to 25.

The sector address decoding unit 131 receives the locked wobble signal, the LPP detection signal, the output of the wobble counter 110 and the output of the frame counter 120, and provides the output signal to the sector counter 130. The sector address decoding unit 131 decodes a 4-bit LPP detection signal while the count value of the frame counter 120 is 2 to 9.

More specifically, as described above, the frame counter 120 counts from 0 to 25, and repeats the counting. The pre-pit patterns detected in the counter values 2 to 9 have four bits, which is defined in advance to have 16 types of values representing 0000 to 1111. The values represent sector addresses.

As described above, the sector counter 130 counts the output signals 0 to 15 of the frame counter 120. For example, when the sector address is represented in the 0th to the third digits, pre-pit patterns are formed as follows. In either a frame having a counter value of 2 or a frame having a counter value of 3, the 0th digit corresponds to a bit value 0 or 1. In either a frame having a counter value of 4 or a frame having a counter value of 5, the first digit corresponds to a bit value 0 or 1. In either a frame having a counter value of 6 or a frame having a counter value of 7, the second digit corresponds to a bit value 0 or 1. In either a frame having a counter value of 8 or a frame having a counter value of 9, the third digit corresponds to a bit value 0 or 1. It is determined for each disc, in advance, in which of these frames the pre-pit pattern is embedded. The sector counter 130 forcibly sets a counter value according to the output of the sector address decoding unit 131. In this manner, the sector counter 130 judges a setting value based on the pre-pit pattern detected while the count value of the frame counter 120 is 2 to 9. Then, even when the pre-pit pattern is detected erroneously, the counting operation is continued.

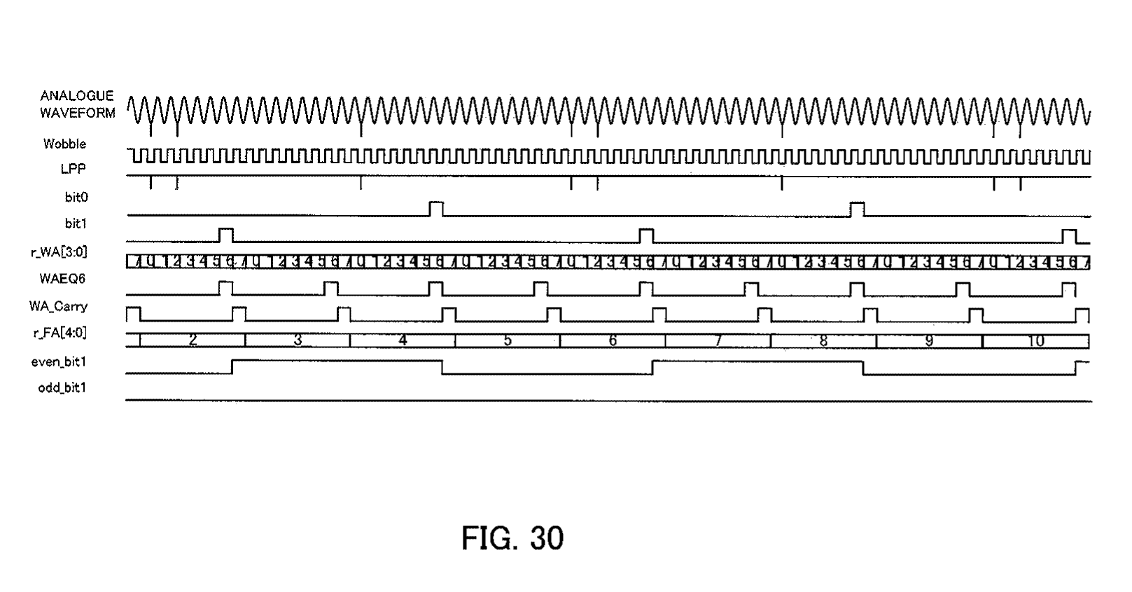

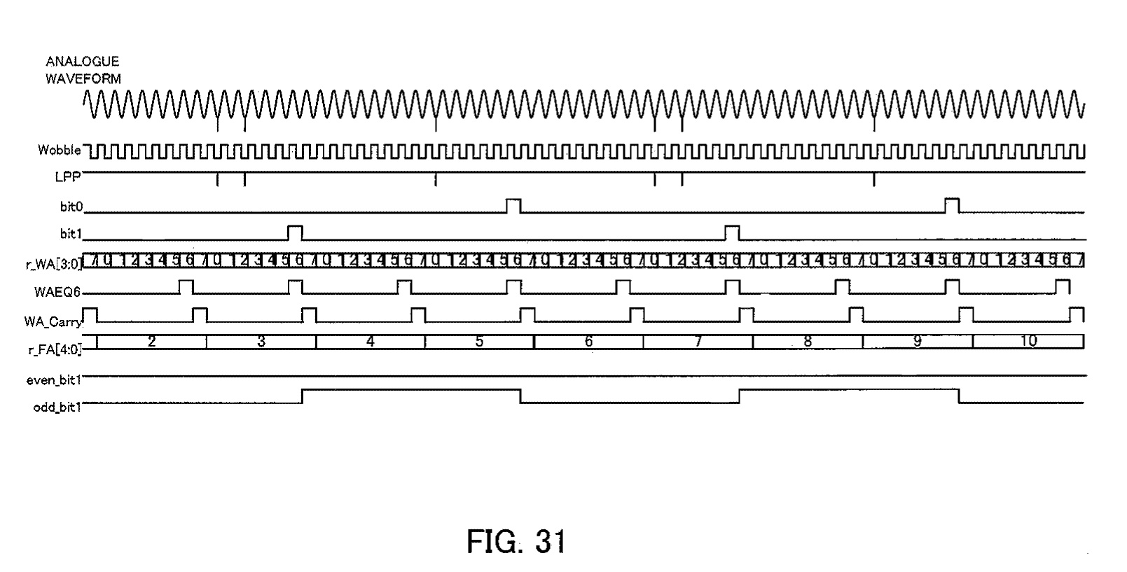

FIGS. 30 and 31 illustrate waveforms and digital values of signals which are inputted into a sector counter and a sector address decoding unit used in the first embodiment, respectively.

FIGS. 30 and 31 show waveforms and digital values produced at times of detecting even and odd frames, respectively.

Each of the counters executes counting operation continuously after the settings are performed according to the above processing order and until subsequent settings are performed.

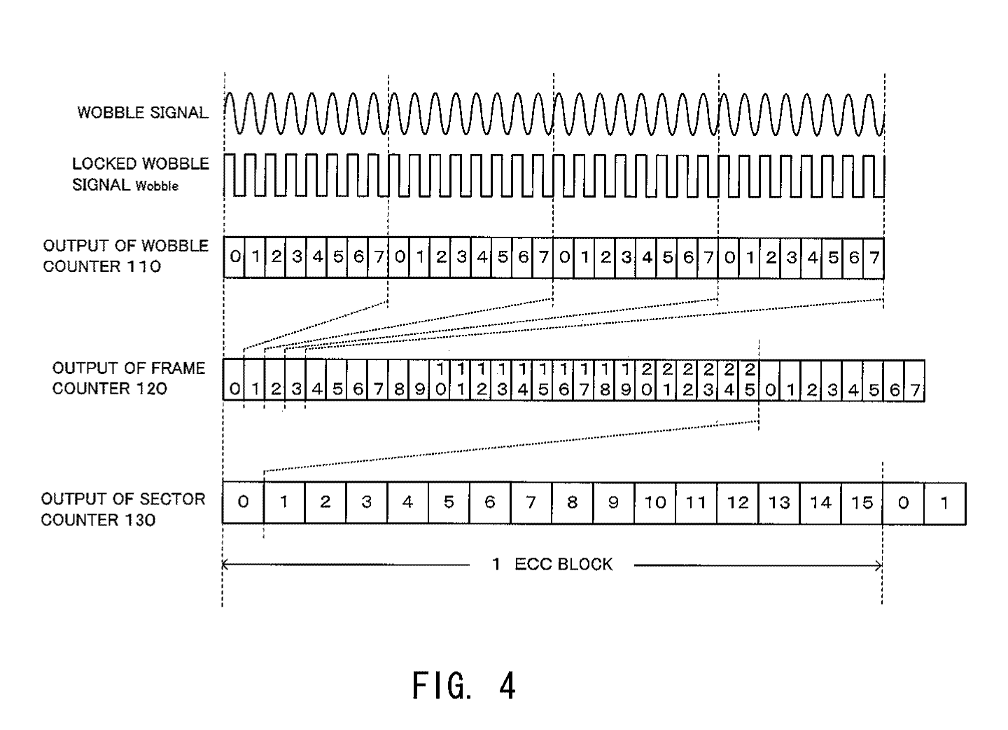

FIG. 4 illustrates a correlation between counter values of the wobble counter 110, the frame counter 120 and the sector counter 130 in a normal state. In each counter output of the frame counter 120, “1” or “2” shown at an upper side represents a numerical value of the ten's digit.

The locked wobble signal is inputted to the even/odd frame judgment unit 2 of FIG. 1. When the even/odd frame judgment unit 2 receives a land pre-pit detection signal from the LPP pattern detection unit 1, the even/odd frame judgment unit 2 obtains frame address information (count value) produced at the time point, from the frame counter 120 of the LPP decoder 100. Then, the even/odd frame judgment unit 2 judges whether the frame where the land pre-pit pattern is detected is an even frame or an odd frame, based on the count value of the frame counter 120.

More specifically, the even/odd frame judgment unit 2 reads the value of the least significant bit of the frame counter 120 when the land pre-pit detection signal is received. When the value is “0”, the even/odd frame judgment unit 2 judges that the land pre-pits are arranged in the even frame. When the value is “1”, the even/odd frame judgment unit 2 judges that the land pre-pits are arranged in the odd frame.

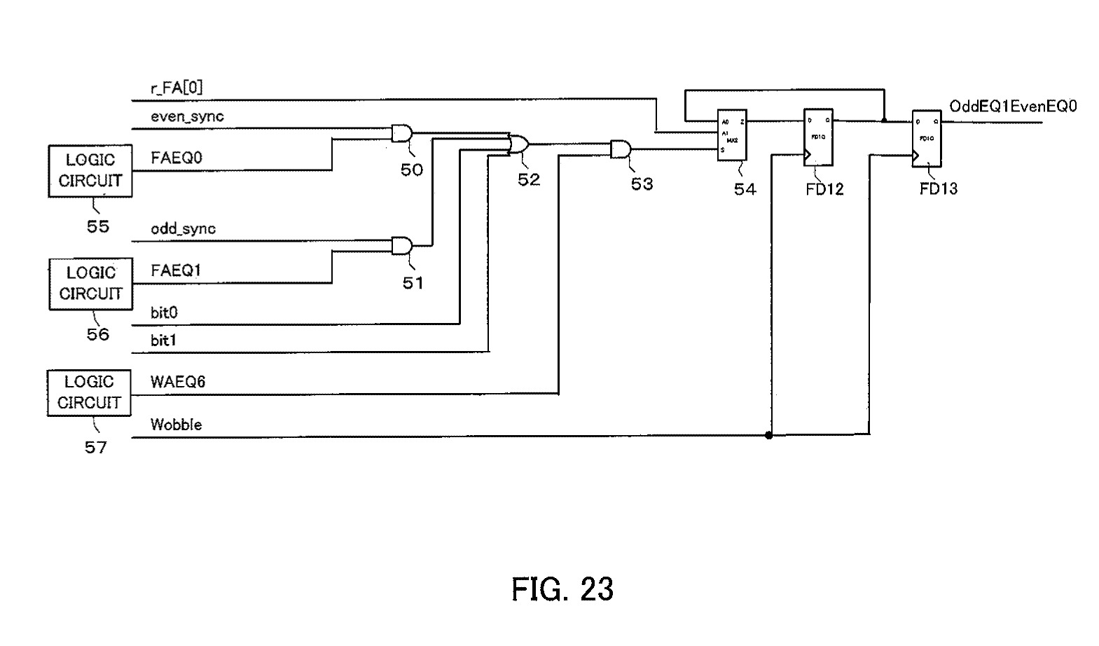

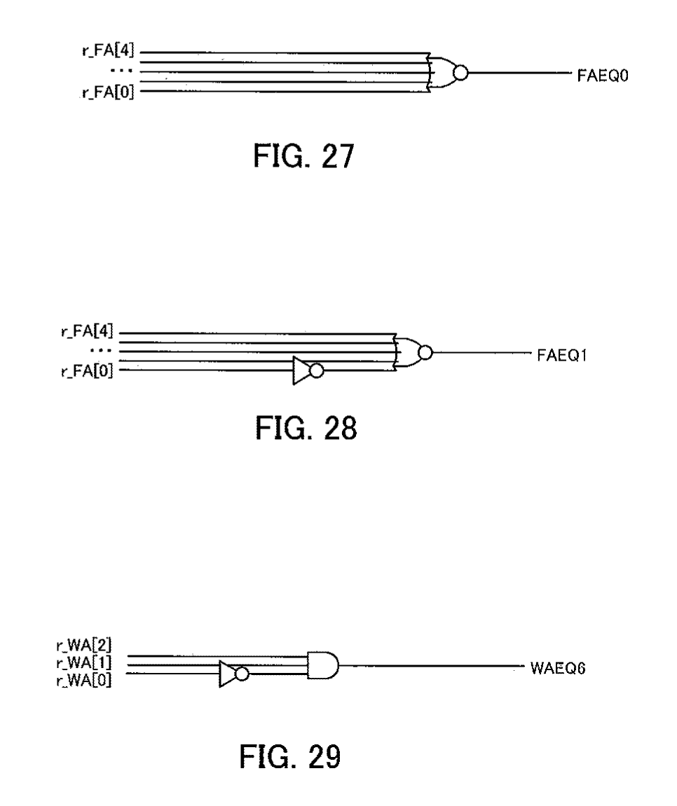

A detailed circuit configuration of the even/odd frame judgment unit 2 is shown in FIG. 23. The even/odd frame judgment unit 2 is provided with AND gates 50, 51 and 53, an OR gate 52, a selector 54 and D-type flip-flops FD12, FD13. The land pre-pit detection signals even_sync, odd_sync are inputted to one input terminals of the AND gates 50, 51, respectively. Signals FAEQ0, FAEQ1 obtained from logic circuits 55, 56 which represent either “0” or “1” of the frame counter 120 are inputted to the other input terminals of the AND gates 50, 51. The logic circuits 55, 56 are shown in detail, for example, in FIGS. 27, 28. The logic circuits 55, 56 is composed of a NOR gate, and the logic circuits 56 is composed of an inverter and a NOR gate. The output signals of the AND gates 50, 51 and the land pre-pit detection signals bit0, bit1 are inputted to the OR gate 52.

The output signal of the OR gate 52 and a signal WAEQ6 “6” of the wobble counter 110 obtained from the logic circuits 57 are inputted to one input terminal of the AND gate 53. The logic circuits 57 is composed of an inverter and a NOR gate shown in FIG. 29. The selector 54 receives the output signal of the AND gate 53, and the signal r_FA[0] and the output signal of the flip-flop FD12. The output signal of the selector 54 is inputted to the flip-flop FD12. Further, the locked wobble signal Wobble is inputted to the flip-flop FD12. The output signal of the flip-flop FD12 and the locked wobble signal Wobble are inputted to the flip-flop FD13. An even/odd judgment signal OddEQ1EvenEQ0 is obtained from the flip-flop FD13.

The synchronization information selection unit 3 of FIG. 1 controls the switch SW on the basis of the judgment result of the even/odd frame judgment unit 2, and selects synchronization information to be recorded in each frame from among plural pieces of synchronization information stored in the synchronization information table 300, and outputs the synchronization information as a signal to be recorded in an optical disc.

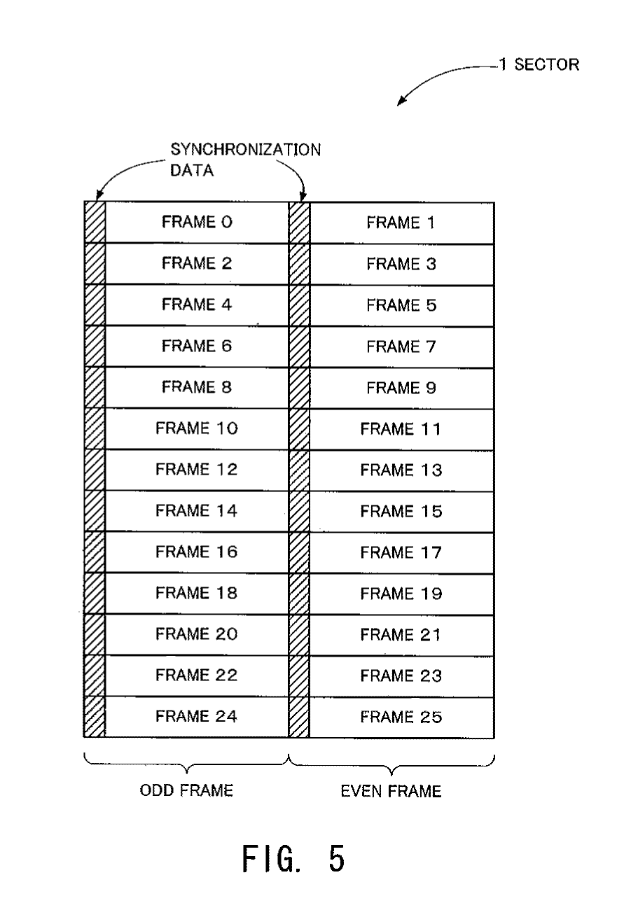

As shown in FIG. 5, the synchronization information is arranged at the head of each frame. The synchronization information selection unit 3 makes selection so that synchronization information of a space of “14T” is arranged in a frame having land pre-pits, and synchronization information of a mark of “14T” is arranged in a frame not having any land pre-pit, in order to avoid bad influence on detection of land pre-pits arranged in a land at the head position of each frame.

More specifically, when the judgment result of the even/odd frame judgment unit 2 is the even frame, the synchronization information selection unit 3 selects synchronization information corresponding to a synchronization pattern of a space of “14T” for the even frame, and selects synchronization information corresponding to a synchronization pattern of a mark of “14T” for the odd frame.

On the other hand, when the judgment result of the even/odd frame judgment unit 2 is an odd frame, the synchronization information selection unit 3 selects synchronization information corresponding to a synchronization pattern of a mark of “14T” for the even frame, and selects synchronization information corresponding to a synchronization pattern of a space of “14T” for the odd frame.

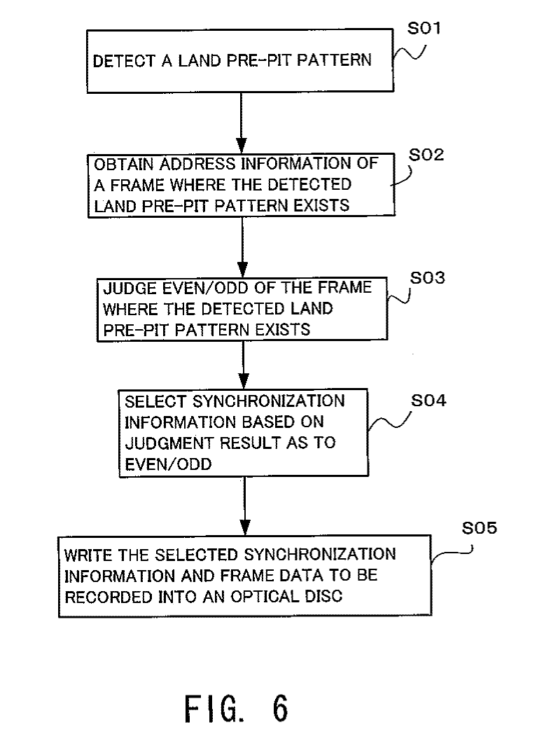

FIG. 6 illustrates an example of flow of selecting and recording operation of synchronization information in the embodiment.

The LPP pattern detection unit 1 detects a land pre-pit pattern from a binary pre-pit signal binarized from a pre-pit signal which is detected from an optical disc (step S01).

The LPP pattern detection unit 1 analyses the binary pre-pit signal, and outputs the land pre-pit detection signal when a bit arrangement corresponding to a pattern of land pre-pits is detected.

When the LPP pattern detection unit 1 outputs the land pre-pit detection signal, the even/odd frame judgment unit 2 obtains frame address information, i.e., frame number, from the frame counter 120 in the LPP decoder 100 (step S02).

Subsequently, the even/odd frame judgment unit 2 judges whether the frame where data pattern of the land pre-pits is detected is an even frame or an odd frame, on the basis of the counter value of the frame counter 120 (step S03).

The synchronization information selection unit 3 selects synchronization information corresponding to a synchronization pattern formed in each frame from among synchronization information corresponding to a plurality of synchronization patterns stored in the synchronization pattern table 300, on the basis of the judgment result of the even/odd frame judgment unit 2 (step S04). The selected synchronization information and frame data to be recorded are written to frames on the optical disc as shown in FIG. 5 (step S05).

When the judgment result of the even/odd frame judgment unit 2 is an even frame in step S04, the synchronization information selection unit 3 selects a synchronization pattern of a space of “14T” for the even frame, and selects a synchronization pattern of a mark of “14T” for the odd frame.

When the judgment result of the even/odd frame judgment unit 2 is an odd frame in step S04, the synchronization information selection unit 3 selects a synchronization pattern of a mark of “14T” for the even frame, and selects a synchronization pattern of a space of “14T” for the odd frame.

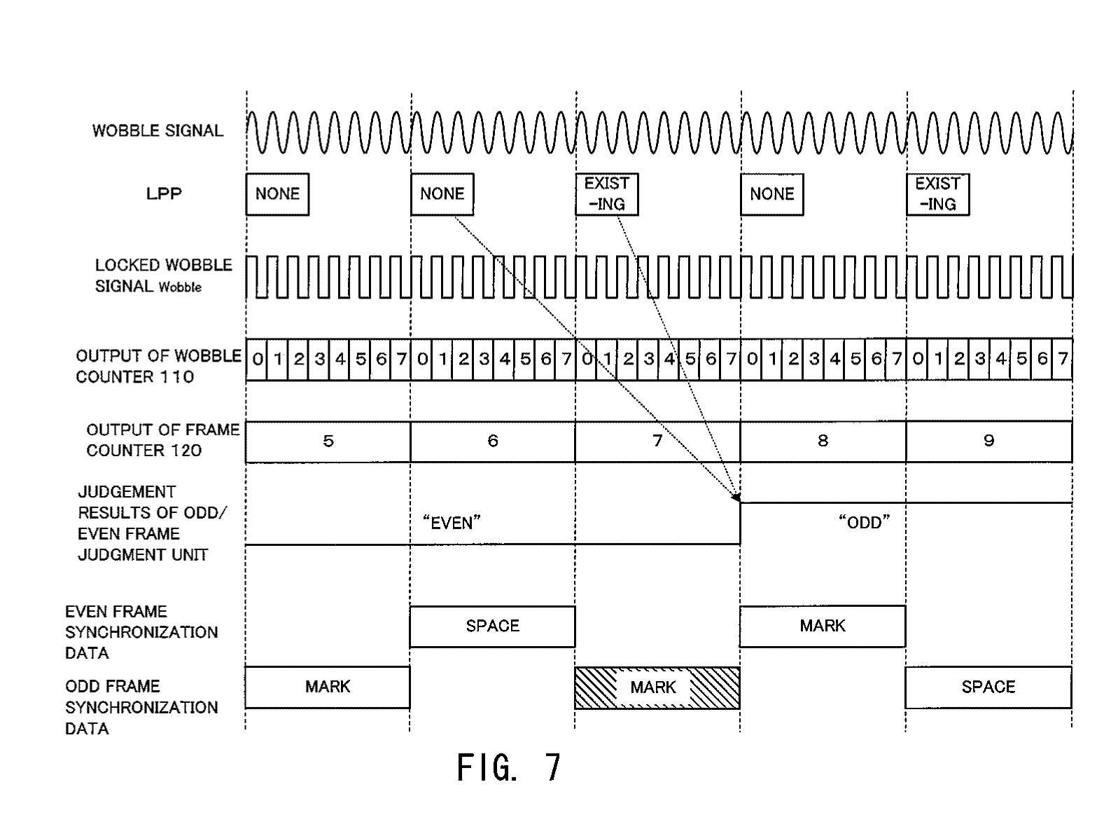

FIG. 7 illustrates waveforms of signals generated when the system according to the embodiment performs the above operation.

In the example as shown in FIG. 7, the frame having the land pre-pits is changed from an even frame to an odd frame. More specifically, land pre-pits as arranged in the even frame in the past are not arranged in the sixth frame, i.e., an even frame, and from the seventh frame, land pre-pits are arranged in an odd frame.

Since the frame 7 having the land pre-pits is changed from the even frame to the odd frame, the judgment result of the even/odd frame judgment unit 2 changes from “even” to “odd”.

Since the judgment result of the even/odd frame judgment unit 2 is changed, the synchronization information selection unit 3 changes the synchronization pattern arranged in an even frame from a space of “14T” to a mark of “14T”. In addition, the synchronization information selection unit 3 changes the synchronization pattern arranged in an odd frame from a mark of “14T” to a space of “14T”.

The judgment result of the even/odd frame judgment unit 2 is fixed at the end time point of recording the seventh frame, and accordingly, the synchronization pattern of the seventh frame is a mark of “14T” though it is originally desired to be a space of “14T”. Thus, in this portion, the arrangement position of the land pre-pits overlaps with the arrangement position of the synchronization pattern of the mark of “14T”. However, this kind of overlapping occurs at an extremely low rate when the entire optical disc is considered. It is because the cycle of change of the number of a frame having land pre-pits between an even number and an odd number is equivalent to about one rotation of the disc, and because in one rotation, of synchronization patterns of about 32 multiplied by 26 frames are arranged even in the innermost circle.

Thus, even if reading error of a land pre-pit occurs, the reading error can be sufficiently corrected.

According to the above embodiment, even when a frame having land pre-pits is changed from an even frame to an odd frame or from an odd frame to an even frame, synchronization information corresponding to a synchronization pattern can be switched according to the change of the frame.

In the first embodiment, the even/odd frame judgment unit 2 makes judgment while data is recorded in an optical disc. Accordingly, some time is necessary to detect the number of a frame having land pre-pits between an even number and an odd number. This causes a delay in outputting a judgment result as described above.

However, a transition address at which the number of a frame having land pre-pits changes between an even number and an odd number is always the same, as long as the optical disc for recording is the same type made by the same manufacturer. Thus, change of the number of LPP arrangement frame between an even number and an odd number may be detected in advance, and the transition address information may be stored. In this case, it is not necessary for the even/odd frame judgment unit 2 to make a judgment every time data is recorded in an optical disc, and this solves the problem of a delay of outputting a judgment result as described above.

An example of an optical disc recording system will be described, in which change of the number of LPP arrangement frame between an even number and an odd number is detected in advance for various types of optical discs and the transition address information is stored for each type of optical disc

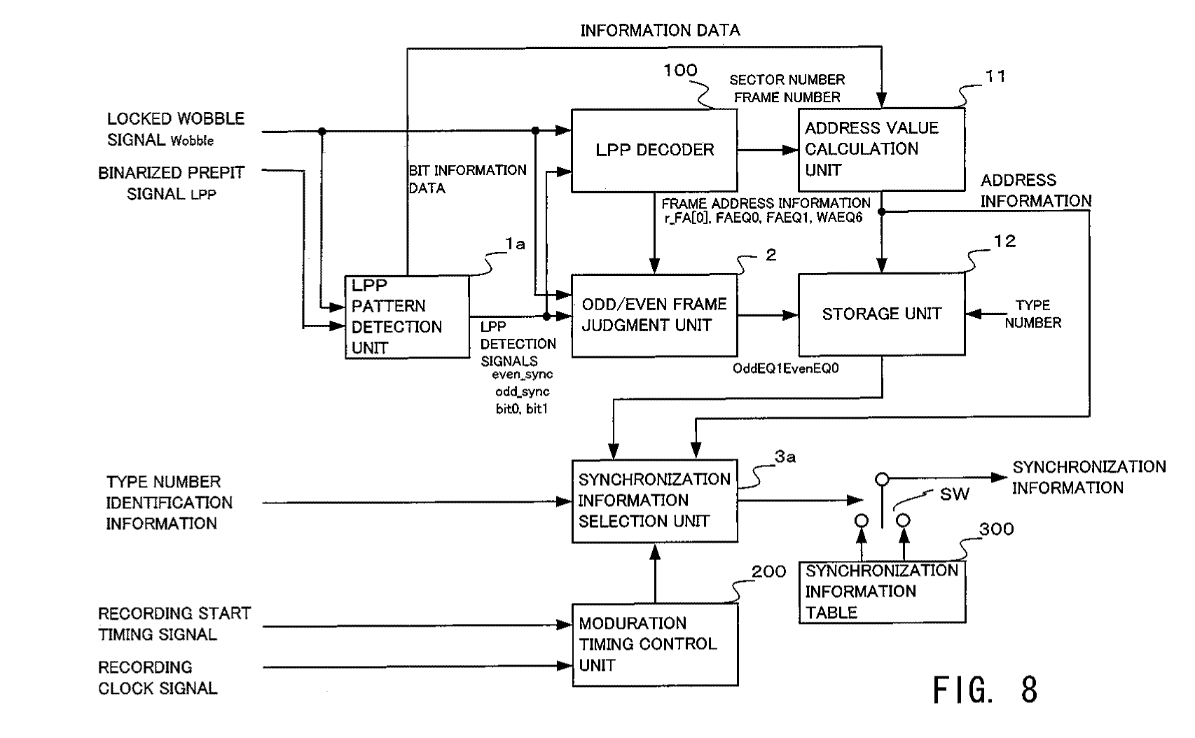

FIG. 8 is a block diagram illustrating an example of a configuration of a system for recording data in an optical disc according to a second embodiment of the invention.

The system according to the second embodiment is provided with not only the units composing the optical disc recording system according to the first embodiment but also an address value calculation unit 11 and a storage unit 12. Further, in the second embodiment, an LPP pattern detection unit la and a synchronization information selection unit 3a include additional functions as described below.

More specifically, the LPP pattern detection unit 1a according to the second embodiment outputs a land pre-pit detection signal to an even/odd frame judgment unit 2. the LPP pattern detection unit 1a outputs data value of information data recorded in land pre-pits serving as pit data information, to an address value calculation unit 11.

The address value calculation unit 11 calculates address information of a frame in which land pre-pits are detected. The address information includes an ECC block address, a sector number, and a frame number representing the position of the frame on the optical disc.

The address value calculation unit 11 obtains 16-byte ECC block address information recorded in land pre-pits from bit data information outputted from the LPP pattern detection unit 1a. Further, the address value calculation unit 11 obtains the sector number and the frame number from the LPP decoder 100.

When the judgment result of the even/odd frame judgment unit 2 changes from an even number to an odd number or from an odd number to an even number, the storage unit 12 obtains address information of the frame at which the transition occurs, from the address value calculation unit 11, in advance. The address information as well as transition direction information are stored in a non-volatile memory such as a flash memory constituting the storage unit 12.

Since the output of the judgment result of the even/odd frame judgment unit 2 is delayed as described above, the storage unit 12 calculates the address value of the frame at which the number changes to an even number or an odd number in such a manner as to compensate the delay by deducting the same.

In the embodiment, the storing processing for the storage unit 12 is performed for each type of optical disc. The storage unit 12 stores the type of the optical disc, the transition direction information as to change of a frame number to an even-number or an odd-number. The storage unit 12 further stores the address information of a frame at which the number changes to an even number or an odd number.

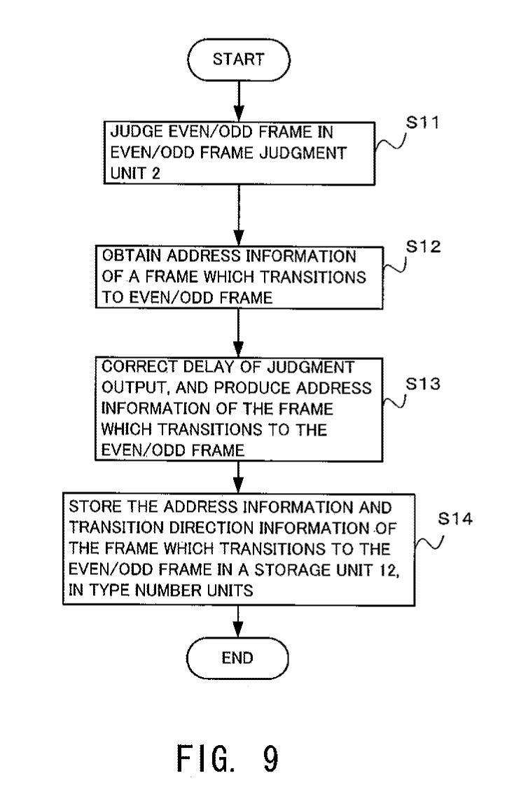

FIG. 9 illustrates a flow of an example of storing address information of a frame at which the number changes to an even/odd frame, to the storage unit 12.

When land detection processing for a certain type of optical disc is started, the even/odd frame judgment unit 2 judges whether a frame having land pre-pits is an even frame or an odd frame (step S11).

The storage unit 12 monitors the judgment result of the even/odd frame judgment unit 2. When the judgment result changes from the even frame to the odd frame or from the odd frame to the even frame, the address information of the changed frame is obtained from the address value calculation unit 11 (step S12).

Then, the storage unit 12 corrects the obtained address information due to delay of judgment caused in the even/odd frame judgment unit 2, and produces corrected address information as to transition to the even/odd frame (step S13).

Subsequently, the storage unit 12 stores the address information of the frame changed to an even/odd number and the transition direction information, in the non-volatile memory, in units of types.

The processing according to the above flow is repeated until reaching the final frame of the optical disc. When the recording is completed, the processing is terminated.

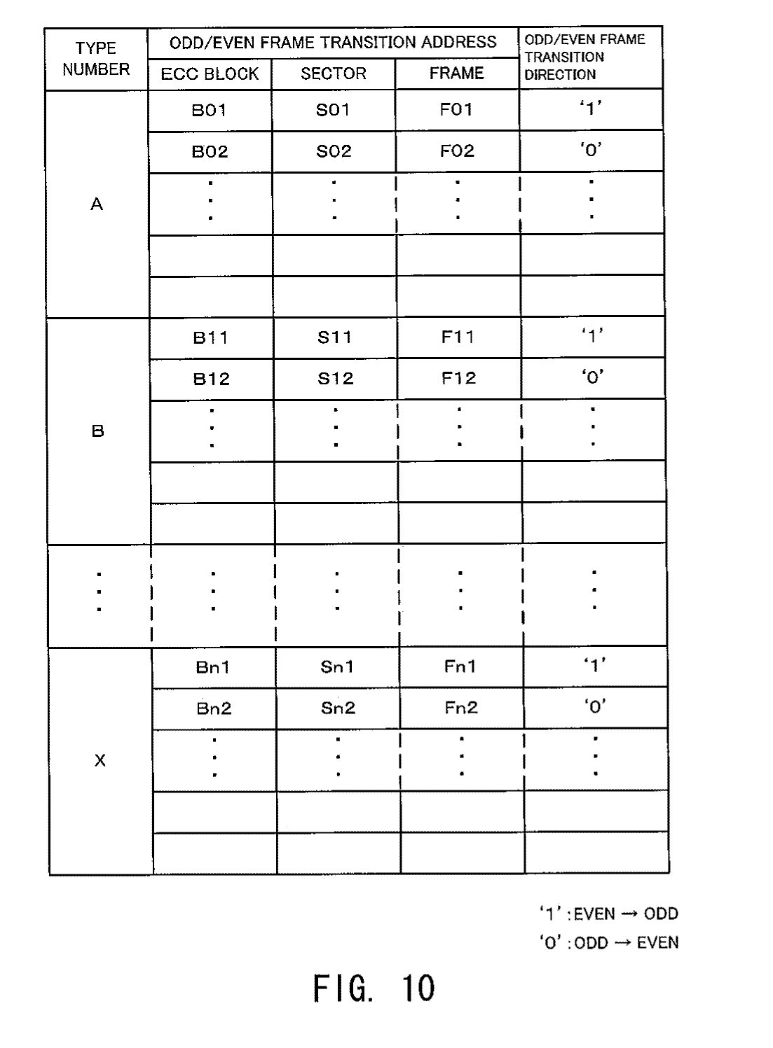

FIG. 10 illustrates example data of address information of a frame at which the number changes to an even/odd frame. The example data of address information is obtained for various type numbers of optical discs A, B, . . . , X and is stored in the storage unit 1, when the processing according to the flow of FIG. 9 described above is repeatedly executed for the optical discs.

According to the example data shown in FIG. 10, address information and transition direction information of a frame at which the number changes to an even/odd frame are stored as one set of data of each row. The address information includes an ECC block number, a sector number, a frame number for each type.

In this example data, the transition direction information showing change to an even/odd frame is represented as follows. “1” represents transition from an even frame to an odd frame. “0” represents transition from an odd frame to an even frame.

Returning to FIG. 8, the synchronization information selection unit 3a according to the second embodiment selects synchronization information, on the basis of type number identification information read from an optical disc, address information of a frame at which the number changes to an even/odd frame, and address information provided from the address value calculation unit 11. The address information is read from the storage unit 12

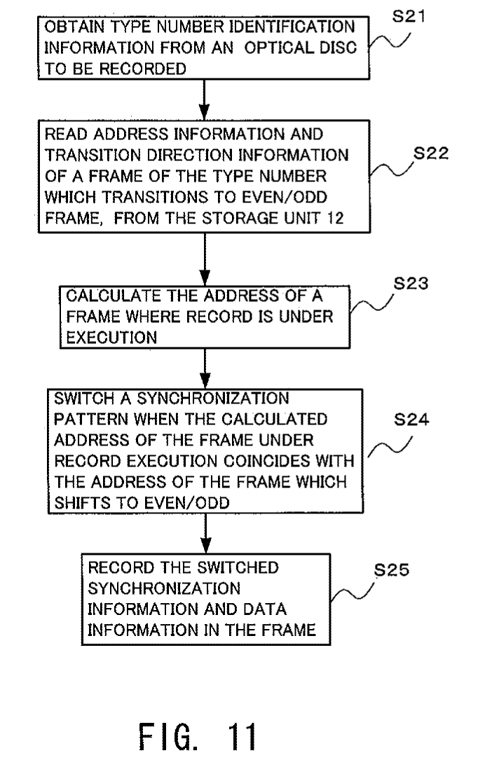

FIG. 11 illustrates an example flow of selecting and recording operation for synchronization information according to the second embodiment. It is assumed that the type number identification information is embedded in land pre-pits of an optical disc in which data is to be recorded.

Detection of land pre-pits formed on the optical disc is started. The synchronization information selection unit 3a obtains the type number identification information which is read from the land pre-pits of the optical disc, based on the above detection (step S21).

Then, the synchronization information selection unit 3a reads address information corrected as described above and transition direction information of a frame at which the number changes to the even/odd frame, from the storage unit 12, for each type number of optical disc (step S22).

The transition direction information and the address information of the frame at which the number changes to the even/odd frame are read and stored in the synchronization information selection unit 3a, during execution of the recording operation.

Then, when the recording operation is started, the synchronization information selection unit 3a calculates an address of a frame for which recording is subsequently executed, on the basis of the address information of a frame in which data is currently recorded. The address information is inputted from the address value calculation unit 11 (step S23).

Further, the synchronization information selection unit 3a compares the calculated address with the address information of the frame at which the number changes to the even/odd frame. When both of the calculated address and the address information of the frame match each other, the synchronization information selection unit 3a changes the synchronization pattern at the head of the frame to which recording is subsequently executed, on the basis of the transition direction information of the transition to an even/odd frame (step S24).

The changed synchronization information and information data to be recorded are recorded in each frame of the optical disc as shown in FIG. 5 (step S24).

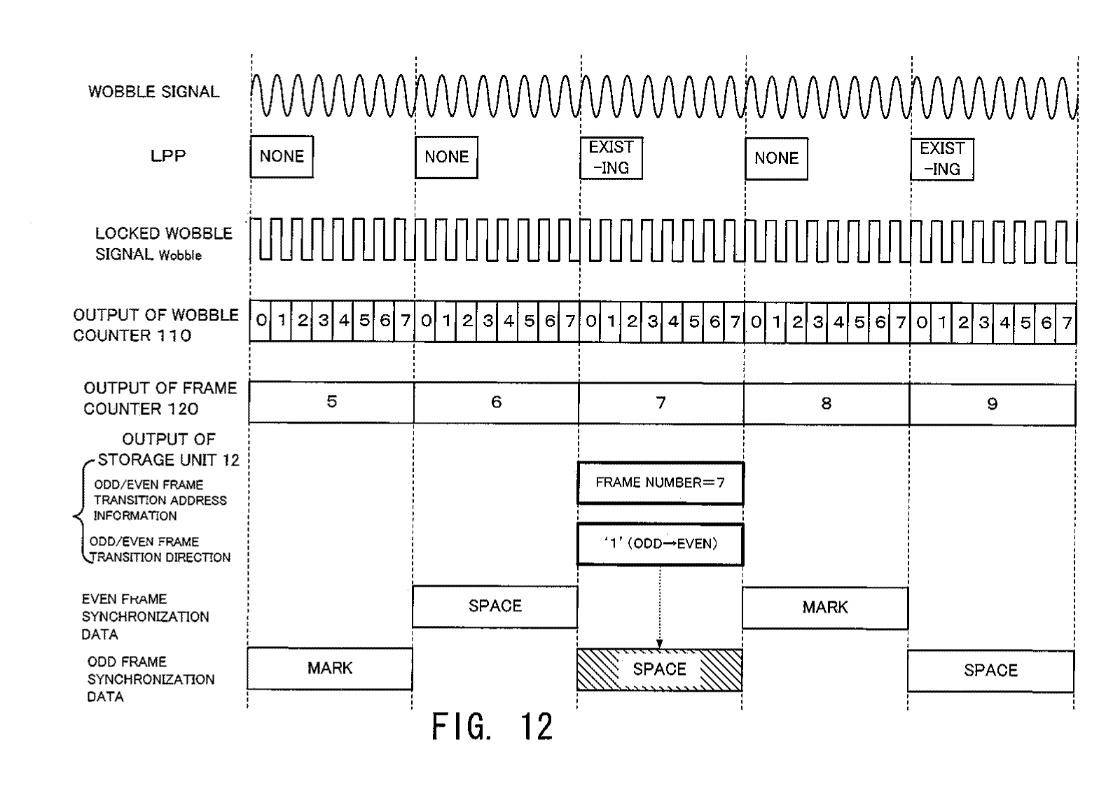

FIG. 12 illustrates waveforms of signals generated when the system according to the second embodiment performs the above operation.

In FIG. 12, similarly to the operation shown in FIG. 7, the number of a frame having land pre-pits is changed from an even to an odd from the seventh frame.

Thus, the address information of the frame at which the frame number changes to even/odd and the transition direction information which are read from the storage unit 12 contain information on frame transition. In FIG. 12, the address information of the frame at which the number changes to the even/odd frame contains a frame number “7”, and the transition direction information contains “1” showing transition from an even number to an odd number.

Accordingly, on the basis of the transition direction information and the address information of the frame at which the number changes to even/odd, the synchronization information selection unit 3a causes a synchronization pattern giving synchronization information arranged in the seventh frame to be a space of “14T”, and causes a synchronization pattern giving synchronization information arranged in each of subsequent odd frames to be a space of “14T”.

Further, the synchronization information selection unit 3a causes a synchronization pattern giving synchronization information arranged in each of even frames subsequent to the eighth frame to be a mark of “14T”.

According to the second embodiment as described above, the synchronization pattern giving the synchronization information is switched on the basis of information of transition to an even/odd frame having land pre-pits which are detected in advance. Thus, this can prevent the arrangement position of a synchronization pattern of a mark of “14T” from being overlapping with the arrangement position of the land pre-pits.

In addition, information of transition to an even/odd frame can be written in the storage unit 12 at any time. Thus, even when, for example, a new type of optical disc is on the market, information of the optical disc regarding transition to an even/odd frame can be immediately written in the storage unit 12, and the arrangement of a synchronization pattern on the optical disc can be appropriately arranged.

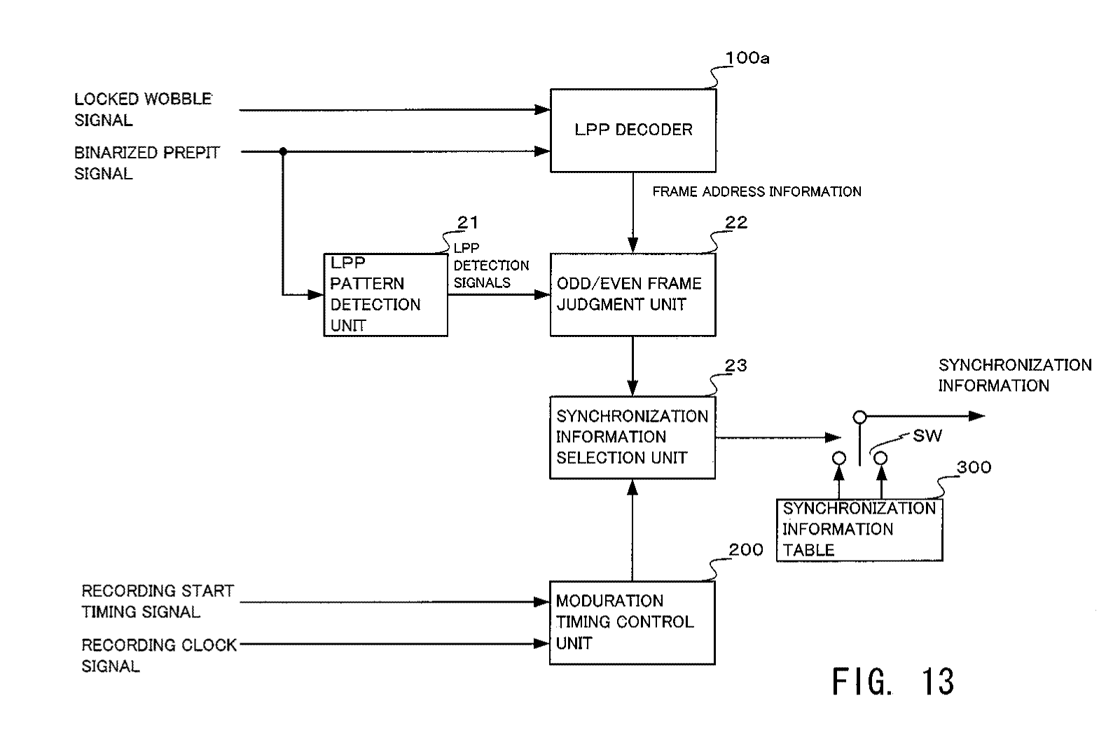

A third embodiment will be described with reference to FIG. 13. FIG. 13 is a block diagram illustrating a system for recording data in an optical disc according to the third embodiment.

As shown in FIG. 13, similarly to a ordinary system for recording data in an optical disc, a system according to the embodiment is provided with a land pre-pit decoder (hereinafter referred to as “LPP decoder”) 100a, a modulation timing control unit 200, and a synchronization information table 300 serving as a synchronization information output unit for storing and outputting plural pieces of synchronization information corresponding to synchronization patterns.

The LPP decoder 100a generates frame address information and sector address information in each ECC block on the optical disc from the locked wobble signal and the LPP detection signal.

The modulation timing control unit 200 receives a recording start timing signal and a recording clock signal, and controls recording timing of a modulation signal to the optical disc.

The modulation timing control unit 200 controls output timing of synchronization information which is outputted from a synchronization information selection unit 23 which will be described below.

The synchronization information table 300 stores at least a plurality of pieces of synchronization information corresponding to synchronization patterns of marks of “14T” and synchronization patterns of spaces of “14T”, respectively, as a plurality of pieces of synchronization information.

The optical disc recording system is further provided with a land pre-pit pattern detection unit (hereinafter referred to as “LPP pattern detection unit”) 21, an even/odd frame judgment unit 22, and a synchronization information selection unit 23. The LPP pattern detection unit 21 detects a pattern of land pre-pits from a binary pre-pit signal. The even/odd frame judgment unit 22 judges whether a frame from which a pattern of land pre-pits is detected by the LPP pattern detection unit 21 is an even frame or an odd frame, on the basis of the frame address information obtained by the LPP decoder 100. The synchronization information selection unit 23 selects a type of a recording pattern of synchronization information recorded in each of the above frames, on the basis of a judgment result provided by the even/odd frame judgment unit 22.

More specifically, a switch SW serving as a selection information output unit is switched based on a selection signal provided from the synchronization information selection unit 23. Synchronization information corresponding to one of a synchronization pattern representing a mark of “14T” and a synchronization pattern representing a space of “14T”, which is stored in the synchronization pattern table 300, is selectively outputted.

FIG. 2A illustrates a relationship between a wobble signal and wobble addresses where land pre-pits are arranged in one frame. FIG. 2B illustrates a relationship between the wobble addresses, synchronization data and information data.

The LPP pattern detection unit 21 of FIG. 13 analyzes the binary pre-pit signal, and when the LPP pattern detection unit 21 detects “pit arrangement” corresponding to any one of the patterns of data as shown in FIG. 2B, the LPP pattern detection unit 21 outputs a land pre-pit detection signal.

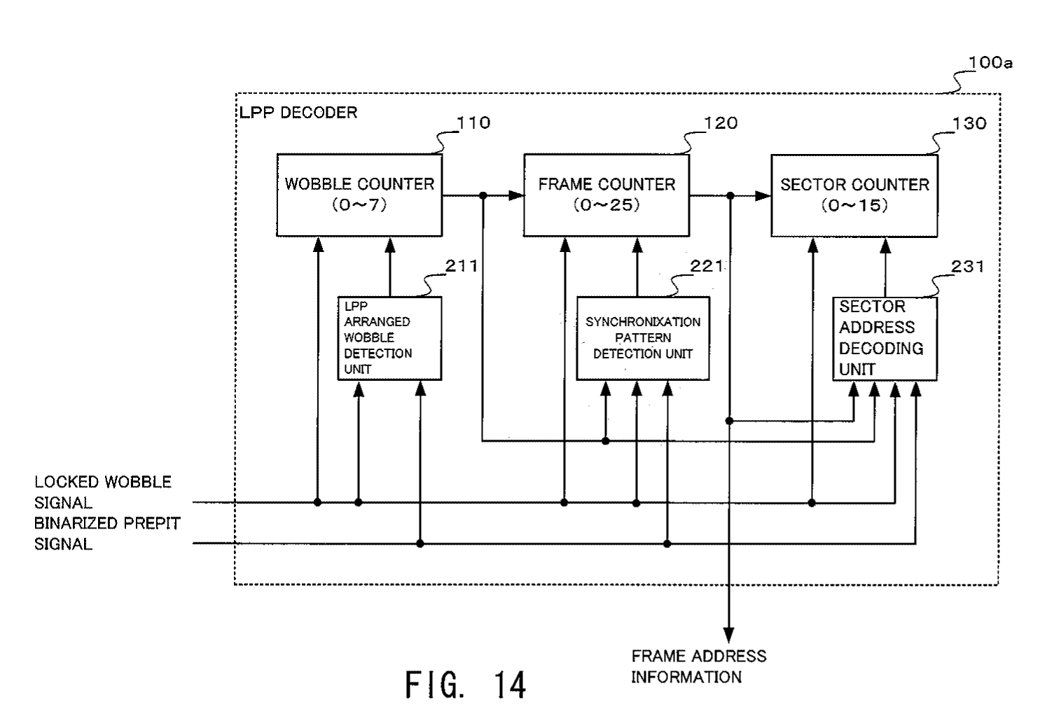

FIG. 14 illustrates an example of an internal configuration of the LPP decoder 100a of FIG. 13.

The LPP decoder 100a includes a wobble counter 110, a frame counter 120, and a sector counter 130. The wobble counter 110 counts locked wobble signals 0 to 7. The frame counter 120 counts output signals 0 to 21 provided by the wobble counter 110. The sector counter 130 counts output signals 0 to 15 provided by the frame counter 120.

Further, the LPP decoder 100a includes an LPP arranged wobble detection unit 211, a synchronization pattern detection unit 221, and a sector address decode unit 231. An LPP arranged wobble detection unit 211 detects a wobble in which a land pre-pit is arranged. The wobble counter 110 counts the locked wobble signal. The frame counter 120 and the sector counter 130 also receive the locked wobble signal.

The LPP arranged wobble detection unit 211 receives the locked wobble signal and the binary pre-pit signal, and outputs a detection signal of a wobble having a land pre-pit to the wobble counter 110. The wobble counter 110 adjusts output timing of counter values 0 to 2 in accordance with an output period of the LPP arranged wobble detection unit 211.

The synchronization pattern detection unit 221 receives the locked wobble signal and the binary pre-pit signal and the output of the wobble counter 110, and outputs a synchronization pattern detection signal to the frame counter 120. When synchronization data of land pre-pits initially detected by the synchronization pattern detection unit 221 is “11100000”, the frame counter 120 initially sets the counter value to “0”. When the synchronization data is “11000000”, the frame counter 120 initially sets the counter value to “1”.

The sector address decoding unit 231 receives the locked wobble signal, the binary pre-pit signal, the output of the wobble counter 110, and the output of the frame counter 120. The sector address decoding unit 231 provides the output signal to the sector counter 130. The sector address decoding unit 231 decodes the 4-bit binary pre-pit signal while the count value of the frame counter 120 is between 2 and 9. More specifically, as described above, the frame counter 120 repeatedly counts 0 to 25. The pre-pit pattern detected in the counter values 2 to 9 has four bits, which is configured to represent 16 types of values from 0000 to 1111. The values represent sector addresses.

As described above, the sector counter 130 counts the output signals 0 to 15 of the frame counter 120. For example, when the sector address is represented in the 0th to the third digits, pre-pit patterns are formed as follows. In either a frame having a counter value of 2 or a frame having a counter value of 3, the 0th digit corresponds to a bit value 0 or 1. In either a frame having a counter value of 4 or a frame having a counter value of 5, the first digit corresponds to a bit value 0 or 1. In either a frame having a counter value of 6 or a frame having a counter value of 7, the second digit corresponds to a bit value 0 or 1. In either a frame having a counter value of 8 or a frame having a counter value of 9, the third digit corresponds to a bit value 0 or 1. It is determined in which of these frames the pre-pit pattern is embedded for each disc, in advance. The sector counter 130 sets a counter value as an initial value according to the output of the sector address decoding unit 231. In this manner, the sector counter 130 judges the initial value based on the pre-pit pattern detected while the count value of the frame counter 120 is 2 to 9. Then, even when error of pre-pit pattern detection occurs, the count operation is continued.

After the initial setting is performed according to the above operation, each counter continuously executes the counting operation until a subsequent initial setting is made. The correlation between counter values of the wobble counter 110, the frame counter 120, and the sector counter 130 is shown in FIG. 4.

When the even/odd frame judgment unit 22 of FIG. 13 receives a land pre-pit detection signal from the LPP pattern detection unit 21, the even/odd frame judgment unit 22 obtains frame address information (count value) caused at the time point, from the frame counter 120 in the LPP decoder 100. Then, the even/odd frame judgment unit 22 judges whether the frame from which the land pre-pit pattern is detected is an even frame or an odd frame, based on the count value of the frame counter 120.

More specifically, the even/odd frame judgment unit 22 reads the value of the least significant bit of the frame counter 120 when the land pre-pit detection signal is received. When the value is determined to be “0”, the even/odd frame judgment unit 22 judges that the land pre-pit is arranged in the even frame. When the value is determined to be “1”, the even/odd frame judgment unit 22 judges that the land pre-pit is arranged in the odd frame.

The synchronization information selection unit 23 of FIG. 13 controls the switch SW on the basis of the judgment result of the even/odd frame judgment unit 22, and selects synchronization information to be recorded in each frame from among a plurality of pieces of synchronization information stored in the synchronization information table 300, and outputs the synchronization information as a signal to be recorded in an optical disc.

As shown in FIG. 5, the synchronization information is arranged at the head of each frame. The synchronization information selection unit 23 makes selection so that synchronization information of a space of “14T” is arranged in a frame having land pre-pits, and synchronization information of a mark of “14T” is arranged in a frame not having any land pre-pit, in order to avoid bad influence on detection of a land pre-pit arranged in a land at the head position of each frame.

More specifically, when the judgment result of the even/odd frame judgment unit 22 is the even frame, the synchronization information selection unit 23 selects synchronization information corresponding to a synchronization pattern of a space of “14T” for the even frame, and selects synchronization information corresponding to a synchronization pattern of a mark of “14T” for the odd frame.

On the other hand, when the judgment result of the even/odd frame judgment unit 22 is the odd frame, the synchronization information selection unit 23 selects synchronization information corresponding to a synchronization pattern of a mark of “14T” for the even frame, and selects synchronization information corresponding to a synchronization pattern of a space of “14T” for the odd frame.

The selecting and recording operation of the synchronization information according to the embodiment is the same as that of the first embodiment shown in FIG. 6.

FIG. 7 illustrates waveforms of signals generated when the system according to the embodiment performs the above operation.

FIG. 7 shows how the frame having land pre-pits is changed from an even frame to an odd frame. More specifically, the land pre-pit arranged in the even frame in the past is not arranged in the sixth frame, i.e., an even frame, and from the seventh frame, the land pre-pit is arranged in an odd frame.

Since the frame 7 having the land pre-pit is changed from the even frame to the odd frame, the judgment result of the even/odd frame judgment unit 22 changes from “even” to “odd”.

Since the judgment result of the even/odd frame judgment unit 22 is changed, the synchronization information selection unit 23 changes the synchronization pattern arranged in the even frame from a space of “14T” to a mark of “14T”. In addition, the synchronization information selection unit 23 changes the synchronization pattern arranged in an odd frame from a mark of “14T” to a space of “14T”.

The judgment result of the even/odd frame judgment unit 22 is fixed at the terminal point of recording the seventh frame, and accordingly, the synchronization pattern of the seventh frame is a mark of “14T” although it is originally desired to be a space of “14T”. Thus, in this portion, the arrangement position of land pre-pit overlaps with the arrangement position of the synchronization pattern of the mark of “14T”. However, this kind of overlapping occurs at an extremely low rate when the entire optical disc is considered. This is because the cycle of change of the number of a frame having land pre-pits between an even number and an odd number is equivalent to about one rotation of the disc, and because in one rotation, about 32 by 26 frames of synchronization patterns are arranged even in the innermost circle.

Thus, even if reading error of a land pre-pit occurs, error correction can be sufficiently performed, which may cause no problem in practical use.

According to the above embodiment, even when a frame having land pre-pits is changed from an even frame to an odd frame or from an odd frame to an even frame, synchronization information corresponding to a synchronization pattern can be switched according to the transition of frame.

In the third embodiment, the even/odd frame judgment unit 22 makes judgment while data is recorded in an optical disc, and it takes some time to detect transition of the number of a frame having land pre-pits between an even number and an odd number, and this causes a delay in the output of the judgment result as described above.

However, a transition address at which the number of a frame having land pre-pits changes between an even number and an odd number is always the same, as long as the used optical disc is the same type made by the same manufacturer. Thus, transition of the number of LPP arrangement frame between an even number and an odd number may be detected in advance, and the transition address information may be stored. In this case, it is not necessary for the even/odd frame judgment unit 22 to make a judgment every time data is recorded in an optical disc, and this solves the problem of the delay of output of the judgment result described above.

An example of an optical disc recording system will be described. In the example transition of the number of LPP arrangement frame between an even number and an odd number is detected in advance, for various types of optical discs, and the transition address information is stored for each type of optical disc

FIG. 15 is a block diagram illustrating a system for recording data in an optical disc according to a fourth embodiment.

The system according to the fourth embodiment is provided with not only the units of the optical disc recording system according to the third embodiment but also an address value calculation unit 11 and a storage unit 12. Further, in the fourth embodiment, an LPP pattern detection unit 21a and a synchronization information selection unit 23a include additional functions, as will be described below.

More specifically, the LPP pattern detection unit 21a according to the fourth embodiment outputs not only a land pre-pit detection signal but also a data value of information data recorded in land pre-pits to an address value calculation unit 11, as pit data information.

The address value calculation unit 11 calculates address information of a frame in which land pre-pits is detected. The address information includes an ECC block address, a sector number, and a frame number representing the position of the frame on the optical disc.

The address value calculation unit 11 obtains 16-byte ECC block address information recorded in land pre-pits from bit data information outputted from the LPP pattern detection unit 21a. Further, the address value calculation unit 11 obtains the sector number and the frame number from an LPP decoder 100a.

When the judgment result of the even/odd frame judgment unit 22 changes from an even number to an odd number or from an odd number to an even number, the storage unit 12 obtains address information of the frame at which the transition occurs from the address value calculation unit 11 in advance, and the address information as well as transition direction information are stored to a non-volatile memory such as a flash memory constituting the storage unit 12.

Since the output of the judgment result of the even/odd frame judgment unit 22 is delayed as described above, the storage unit 12 calculates the address value of the frame at which the number changes to an even number or an odd number in such a manner as to compensate the delay by deducting the same.

In the embodiment, the storing process to the storage unit 12 is performed for each type of optical disc. The storage unit 12 stores the type number of optical disc, the transition direction information showing change of a frame number to an even-number or an odd-number, and the address information of a frame at which the number changes to an even number or an odd number.

The storing processing for address information of a frame at which the number changes to an even/odd frame is the same as that of the first embodiment as shown in FIG. 9.

When the processing according to the flow of FIG. 9 described above is repeatedly executed for optical discs of various kinds of types A, B, . . . , X, data of address information of a frame at which the number changes to an even/odd frame for each type are the same as the data of the first embodiment as shown in FIG. 10.

Returning to FIG. 15, the synchronization information selection unit 23a according to the fourth embodiment selects synchronization information, on the basis of type number identification information read from the optical disc, address information of a frame at which the number changes to an even/odd frame, and address information provided from the address value calculation unit 11. The address information of the frame is read from the storage unit 12.

The selecting and recording operation of synchronization information according to the fourth embodiment is the same as that of the first embodiment as shown in FIG. 11.

The waveforms of signals generated by the above processing performed by the system according to the fourth embodiment are the same as waveforms of signals generated by the system according to the second embodiment as shown in FIG. 12.

In FIG. 12, similarly to the operation shown in FIG. 7, a frame having land pre-pits is changed from an even frame to an odd frame after the seventh frame.

Thus, the address information of the frame at which the number changes to the even/odd frame and the transition direction information mentions information of the frame transition. In FIG. 12, the address information of the frame at which the number changes to the even/odd frame includes frame number “7”, and the transition direction information includes “1” (transition from an even number to an odd number).

Accordingly, on the basis of the transition direction information and the address information of the frame at which the number changes to the even/odd frame, the synchronization information selection unit 23a causes a synchronization pattern giving synchronization information arranged in the seventh frame to be a space of “14T”, and causes a synchronization pattern giving synchronization information arranged in each of subsequent odd frames to be a space of “14T”.

Further, the synchronization information selection unit 23a causes a synchronization pattern giving synchronization information arranged in each of even frames subsequent to the eighth frame to be a mark of “14T”.

According to the fourth embodiment as described above, the synchronization pattern giving the synchronization information is switched on the basis of information of transition to an even/odd frame from a frame having land pre-pits detected in advance. Thus, this can prevent the arrangement position of the synchronization pattern of the mark of “14T” from being overlapped with the arrangement position of the land pre-pit.

In addition, information of transition to an even/odd frame can be written to the storage unit 12 at any time. Thus, even when, for example, a new type of optical disc is on the market, information of the optical disc regarding transition to an even/odd frame can be immediately written to the storage unit 12, and the arrangement of the synchronization pattern on the optical disc can be appropriately arranged.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system for recording data in an optical disc having frames having different numbers, the system recording data in each of the frames while writing synchronization information in each frame, comprising:
an even/odd frame judgment unit configured to judge whether the number of a frame having a land pre-pit is an even number or an odd number, on the basis of a signal obtained by detecting the land pre-pit;
a synchronization information output unit configured to output plural pieces of synchronization information corresponding to different synchronization patterns;
a synchronization information selection unit configured to generate a selection signal for selecting one of the pieces of synchronization information to be written in each frame, on the basis of the judgment result obtained from the even/odd frame judgment unit; and
a selection information output unit configured to output the selected one of the pieces of synchronization information on the basis of the selection signal obtained from the synchronization information selection unit.

2. The system according to claim 1, wherein the even/odd frame judgment unit judges whether the number of the frame is an even number or an odd number on the basis of the signal and frame address information obtained by detecting the land pre-pit.

3. The system according to claim 1, wherein, when the judgment result of the even/odd frame judgment unit is an even frame, the synchronization information selection unit selects a space as the synchronization pattern to be recorded in an even frame and selects a mark as the synchronization pattern to be recorded in an odd frame, and wherein, when the judgment result of the even/odd frame judgment unit is an odd frame, the synchronization information selection unit selects a mark as the synchronization pattern to be recorded in an even frame and selects a space as the synchronization pattern to be recorded in an odd frame.

4. The system according to claim 1, further comprising a land pre-pit pattern detection unit and a land pre-pit decoder,
wherein the land pre-pit pattern detection unit receives a pre-pit signal obtained by detecting the land pre-pit and detects a land pre-pit pattern, and the land pre-pit decoder receives the pre-pit signal and a wobble signal obtained by detecting the optical disc and generates at least frame address information.

5. The system according to claim 4, further comprising a modulation timing control unit,
wherein the modulation timing control unit receives a recording start timing signal and a recording clock signal and controls output timing of the synchronization information.

6. The system according to claim 1, wherein the pieces of synchronization information include spaces and marks.

7. The system according to claim 1, wherein information to be written in the land pre-pit is different depending on whether the frame is an even frame or an odd frame.

8. The system according to claim 1, wherein the synchronization information output unit includes a switch.

9. A system for recording data in an optical disc having frames having different numbers, the system recording data in each of the frames while writing synchronization information in each frame, comprising:
an even/odd frame judgment unit configured to judge whether the number of a frame having a land pre-pit is an even number or an odd number, on the basis of a signal obtained by detecting the land pre-pit;
a synchronization information output unit configured to output plural pieces of synchronization information corresponding to different synchronization patterns;
an address value calculation unit configured to calculate first address information of a frame from which existing of a land pre-pit is detected, on the basis of a signal obtained by detecting the land pre-pit;
a storage unit configured to obtain, as second address information, the first address information and a frame number of a frame having a land pre-pit changed from an even frame to an odd frame or from an odd frame to an even frame, on the basis of the judgment result provided from the even/odd frame judgment unit, the a storage unit storing the obtained second address information and a type of the optical disc;
a synchronization information selection unit configured to generate a selection signal for selecting one of the pieces of synchronization information to be written in each frame, on the basis of the second address information read from the storage unit according to a type number identification information read from the optical disc and the first address information of the frame from which existing of the land pre-pit is detected; and
a selection information output unit configured to output the selected one of the pieces of synchronization information on the basis of the selection signal obtained from the synchronization information selection unit.

10. The system according to claim 9, wherein the storage unit calculates and stores an address value of a frame at which the number of the frame changes from an even number to an odd number or from an odd number to an even number, so that the delay of judgment caused by the even/odd frame judgment unit is compensated.

11. The system according to claim 9, wherein the storage unit stores transition direction information in addition to the address value of the frame at which the number of the frame changes from an even number to an odd number or from an odd number to an even number.

12. The system according to claim 9, wherein the even/odd frame judgment unit judges whether the number of the frame is an even number or an odd number on the basis of the signal and frame address information obtained by detecting the land pre-pit.

13. The system according to claim 10, wherein, when the judgment result of the even/odd frame judgment unit is an even frame, the synchronization information selection unit selects a space as the synchronization pattern to be recorded in an even frame and selects a mark as the synchronization pattern to be recorded in an odd frame, and wherein, when the judgment result of the even/odd frame judgment unit is an odd frame, the synchronization information selection unit selects a mark as the synchronization pattern to be recorded in an even frame and selects a space as the synchronization pattern to be recorded in an odd frame.

14. The system according to claim 9, further comprising a land pre-pit pattern detection unit and a land pre-pit decoder,
wherein the land pre-pit pattern detection unit receives a pre-pit signal obtained by detecting the land pre-pit and detects a land pre-pit pattern, and the land pre-pit decoder receives the pre-pit signal and a wobble signal obtained by detecting the optical disc and generates at least frame address information.

15. The system according to claim 14, further comprising a modulation timing control unit,
wherein the modulation timing control unit receives a recording start timing signal and a recording clock signal and controls output timing of the synchronization information.

16. The system according to claim 9, wherein the pieces of synchronization information include spaces and marks.

17. The system according to claim 9, wherein information to be written in the land pre-pit is different depending on whether the frame is an even frame or an odd frame.

18. The system according to claim 9, wherein the synchronization information output unit includes a switch.
